(19) United States
(12) Patent Application Publication
(10) Pub. No.: US 2025/0317075 A1
(43) Pub. Date: Oct. 9, 2025

(54) BIDIRECTIONAL CHARGER

(71) Applicant: KABUSHIKI KAISHA TOYOTA JIDOSHOKKI, Aichi-ken (JP)

(72) Inventor: Takahiro SUZUKI, Kariya-shi (JP)

(73) Assignee: KABUSHIKI KAISHA TOYOTA JIDOSHOKKI, Aichi-ken (JP)

(21) Appl. No.: 19/098,599

(22) Filed: Apr. 2, 2025

(30) Foreign Application Priority Data
Apr. 4, 2024 (JP) 2024-060909

(51) Int. Cl. H02M 7/797; B60L 53/22; H02J 7/00; H02M 3/335; H02M 7/81

(52) U.S. Cl. CPC H02M 7/797; B60L 53/22; H02J 7/0063; H02M 3/33573; H02M 3/33584; H02M 7/81; B60L 2210/30; H02J 2207/20

(57) ABSTRACT

In single-phase connection in a bidirectional charger that can perform the charging of a battery, or single-phase three-wire power supplying, a deterioration in performance is avoided in single-phase three-wire power supplying. The bidirectional charger includes: a first bidirectional inverter circuit that is connected to first and second input/output terminals; a second bidirectional inverter circuit that is connected to the first input/output terminal and a neutral terminal; a first bidirectional DCDC converter circuit that outputs, to a battery, power from the first bidirectional inverter circuit, and outputs, to the first bidirectional inverter circuit, power from the battery; a second bidirectional DCDC converter circuit that outputs, to the battery, power from the second bidirectional inverter circuit, and outputs, to the second bidirectional inverter circuit, power from the battery; and a control unit that controls the first and second bidirectional inverter circuits and the first and second bidirectional DCDC converter circuits.

### CROSS-REFERENCE TO RELATED APPLICATION

This application is based upon and claims the benefit of priority to Japanese Patent Application No. 2024-060909, filed on Apr. 4, 2024, the entire contents of which are incorporated herein by reference.

### FIELD

The present invention relates to a bidirectional charger.

### BACKGROUND

A bidirectional charger that converts AC power that has been supplied from a commercial power supply into DC power by using a bidirectional inverter circuit, converts the DC power into predetermined DC power by using a bidirectional DCDC converter circuit, and outputs the predetermined DC power to a battery at the time of charging the battery, and that converts DC power that has been supplied from the battery into predetermined DC power by using the bidirectional DCDC converter circuit, converts the predetermined DC power into AC power by using the bidirectional inverter circuit, and outputs the AC power to a load at the time of supplying power in a single-phase two-wire system, is available. An example of a related technology is JP 2022-164539 A.

However, the feeding of power to a three-phase load is disclosed, as illustrated in FIG. 5 of JP 2022-164539 A, but a single-phase three-wire power feeding method is not clearly described.

### SUMMARY

It is an object in one aspect of the present invention to cope with the imbalance in power consumption between loads at the time of supplying power in a single-phase three-wire system, in a bidirectional charger that can charge a battery, or can supply power in the single-phase three-wire system.

A bidirectional charger in one aspect of the present invention includes: a first input/output terminal that is connected to a first load; a second input/output terminal that is connected to a second load that is connected in series to the first load; a neutral terminal that is connected to a connection point between the first load and the second load, and is grounded; a first bidirectional inverter circuit that is connected to the first input/output terminal and the second input/output terminal; a second bidirectional inverter circuit that is connected to the first input/output terminal and the neutral terminal; a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit; a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and a control unit that controls the first bidirectional inverter circuit, the second bidirectional inverter circuit, the first bidirectional DCDC converter circuit, and the second bidirectional DCDC converter circuit.

Therefore, by simultaneously controlling the first bidirectional inverter circuit, the second bidirectional inverter circuit, the first bidirectional DCDC converter circuit, and the second bidirectional DCDC converter circuit, in a case where power consumed by the first load is greater than power consumed by the second load, power obtained by subtracting the power consumed by the second load from the power consumed by the first load can be supplied to the first load via the second bidirectional DCDC converter circuit and the second bidirectional inverter circuit. Furthermore, in a case where the power consumed by the second load is greater than the power consumed by the first load, power obtained by subtracting the power consumed by the first load from the power consumed by the second load can be regenerated and resupplied to the battery via the second bidirectional inverter circuit and the second bidirectional DCDC converter circuit.

Furthermore, a bidirectional charger in one aspect of the present invention includes: a first input/output terminal that is connected to a first load; a second input/output terminal that is connected to a second load that is connected in series to the first load; a neutral terminal that is connected to a connection point between the first load and the second load, and is grounded; a first bidirectional inverter circuit that is connected to the first input/output terminal and the second input/output terminal; a second bidirectional inverter circuit that is connected to the first input/output terminal; a switch in which one end is connected to the second bidirectional inverter circuit, and another end is switchably connected to the neutral terminal and the second input/output terminal; a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit; a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and a control unit that controls the first bidirectional inverter circuit, the second bidirectional inverter circuit, the first bidirectional DCDC converter circuit, and the second bidirectional DCDC converter circuit.

Therefore, in a case where an external AC power supply is connected to the first input/output terminal and the second input/output terminal, and the other end of the switch is connected to the second input/output terminal, DC power can be supplied via the first bidirectional inverter circuit and the first bidirectional DCDC converter circuit to the battery, and DC power can be supplied via the second bidirectional inverter circuit and the second bidirectional DCDC converter circuit to the battery.

Furthermore, the first bidirectional inverter circuit may include: a first arm to which a first switching element and a second switching element are connected in series; a second arm to which a third switching element and a fourth switching element are connected in series; a third arm to which a fifth switching element and a sixth switching element are connected in series; a first coil in which one end is connected to a connection point between the first switching element and the second switching element, and another end is connected to the first input/output terminal; and a second coil in which one end is connected to a connection point between the third switching element and the fourth switching element, and another end is connected to the first input/output terminal, the first arm, the second arm, and the third arm may be connected in parallel, and a connection point between the fifth switching element and the sixth switching element may be connected to the second input/output terminal, the second bidirectional inverter circuit may include: a fourth arm to which a seventh switching element and an eighth switching element are connected in series; a fifth arm to which a ninth switching element and a tenth switching element are connected in series; a sixth arm to which an eleventh switching element and a twelfth switching element are connected in series; a third coil in which one end is connected to a connection point between the seventh switching element and the eighth switching element, and another end is connected to the first input/output terminal; and a fourth coil in which one end is connected to a connection point between the ninth switching element and the tenth switching element, and another end is connected to the first input/output terminal, and the fourth arm, the fifth arm, and the sixth arm may be connected in parallel, and a connection point between the eleventh switching element and the twelfth switching element may be connected to the neutral terminal.

Therefore, an increase in the number of arms of the first bidirectional inverter circuit enables single-phase three-wire output, even if the first bidirectional inverter circuit in which the first arm and the second arm are of the interleaved type, and the second bidirectional inverter circuit in which the fourth arm and the fifth arm are of the interleaved type are employed, and this can avoid a deterioration in performance of elements.

Furthermore, the first bidirectional inverter circuit may include: a first arm to which a first switching element and a second switching element are connected in series; a second arm to which a third switching element and a fourth switching element are connected in series; a third arm to which a fifth switching element and a sixth switching element are connected in series; a first coil in which one end is connected to a connection point between the first switching element and the second switching element, and another end is connected to the first input/output terminal; and a second coil in which one end is connected to a connection point between the third switching element and the fourth switching element, and another end is connected to the first input/output terminal, the first arm, the second arm, and the third arm may be connected in parallel, and a connection point between the fifth switching element and the sixth switching element is connected to the second input/output terminal, the second bidirectional inverter circuit may include: a fourth arm to which a seventh switching element and an eighth switching element are connected in series; a fifth arm to which a ninth switching element and a tenth switching element are connected in series; a sixth arm to which an eleventh switching element and a twelfth switching element are connected in series; a third coil in which one end is connected to a connection point between the seventh switching element and the eighth switching element, and another end is connected to the first input/output terminal; and a fourth coil in which one end is connected to a connection point between the ninth switching element and the tenth switching element, and another end is connected to the first input/output terminal, and the fourth arm, the fifth arm, and the sixth arm may be connected in parallel, and a connection point between the eleventh switching element and the twelfth switching element may be connected to the one end of the switch.

Therefore, an increase in the number of arms of the first bidirectional inverter circuit enables single-phase three-wire output, even if the first bidirectional inverter circuit in which the first arm and the second arm are of the interleaved type, and the second bidirectional inverter circuit in which the fourth arm and the fifth arm are of the interleaved type are employed.

### BRIEF DESCRIPTION OF DRAWINGS

FIG. 1 is a diagram illustrating an example of a bidirectional charger according to a first embodiment;

FIG. 2 is a diagram illustrating an example of a bidirectional DCDC converter circuit;

FIG. 3 is a flowchart illustrating an operation of a control unit at the time of supplying power in a single-phase three-wire system according to the first embodiment;

FIG. 4 is a diagram illustrating an example of a bidirectional charger according to a second embodiment; and

FIG. 5 is a flowchart illustrating an operation of a control unit at the time of supplying power in the single-phase three-wire system according to the second embodiment.

### DESCRIPTION OF EMBODIMENTS

Embodiments will be described below in detail with reference to the drawings.

### First Embodiment

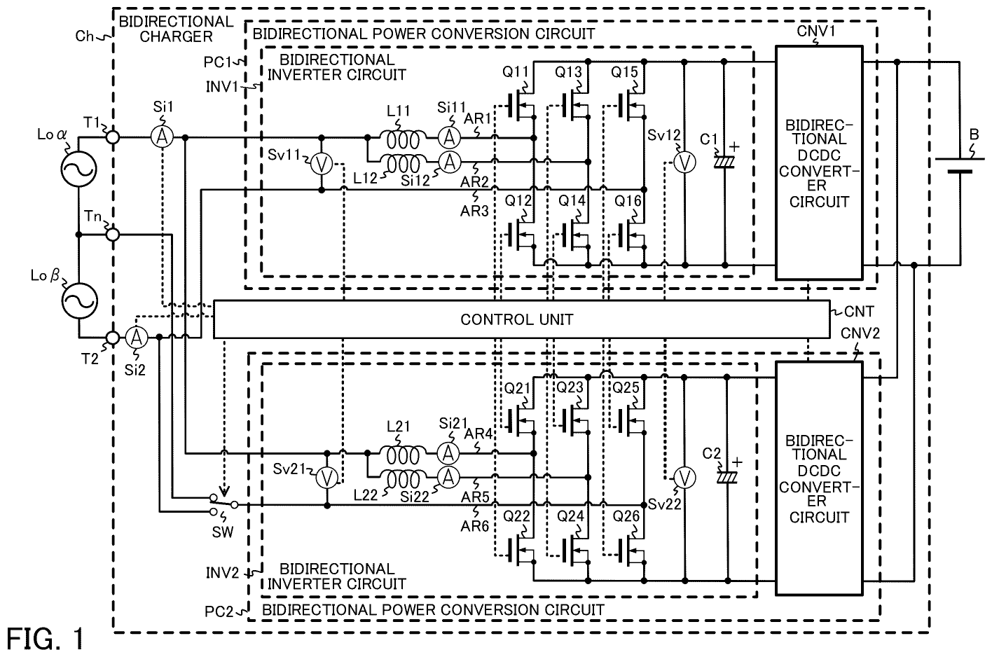

FIG. 1 is a diagram illustrating an example of a bidirectional charger according to a first embodiment.

A bidirectional charger Ch illustrated in FIG. 1 is mounted on a vehicle such as an electric vehicle or a plug-in hybrid vehicle, and has a function of converting AC power that has been supplied from a commercial power supply into DC power, and outputting the DC power to a battery B mounted on the vehicle to charge the battery B, and a function of converting DC power that has been supplied from the battery B into AC power, and supplying the AC power to a load such as an electrical product by using a single-phase three-wire system to drive the load. Note that it is assumed that power is supplied from a not-illustrated commercial power supply (an external AC power supply) to the bidirectional charger Ch at the time of charging the battery B.

Furthermore, the bidirectional charger Ch includes an input/output terminal T1 (a first input/output terminal) that is connected to a load Loα (a first load), an input/output terminal T2 (a second input/output terminal) that is connected to a load Loβ (a second load) that is connected in series to the load Loα, and a neutral terminal Tn that is connected to a connection point between the load Loα and the load Loβ, and is grounded. The load Loα and the load Loβ may be directly connected to the input/output terminal T1, the input/output terminal T2, and the neutral terminal Tn, or may be connected via a wiring line to the input/output terminal T1, the input/output terminal T2, and the neutral terminal Tn. It is assumed that the loads Loα and Loβ are electrical products that operate at AC 100 V, or the like. It is assumed that the current consumption of the load Loα is Iα, and the current consumption of the load Loβ is Iβ. Accordingly, power consumption at a time when the current consumption Iα has flowed through the load Loα at AC 100 V is power consumption α, and power consumption at a time when the current consumption Iβ has flowed through the load Loβ at AC 100 V is power consumption β. The power consumption α and the power consumption β are not necessarily constant, and the power consumption α and the power consumption β can change according to a change in current consumption. The power consumption α and the power consumption β may have the same value, the power consumption α may be greater than the power consumption β, or the power consumption β may be greater than the power consumption α. Furthermore, at the time of supplying power in the single-phase three-wire system, a voltage to be applied between the input/output terminal T1 and the neutral terminal Tn, and a voltage to be applied between the input/output terminal T2 and the neutral terminal Tn are controlled to have an equal value of AC 100 V. In a case where the loads Loα and Loβ are not distinguished from each other, they are simply referred to as loads Lo.

Furthermore, it is assumed that the battery B is a chargeable/dischargeable battery such as a lithium-ion secondary battery, and is, for example, a chargeable/dischargeable battery for supplying power to a driving device such as a travelling motor, or a chargeable/dischargeable battery for supplying power to electric equipment such as an air compressor or a vehicle-side control unit that controls the driving of a vehicle.

Moreover, the bidirectional charger Ch includes a current sensor Si1, a current sensor Si2, a switch SW, a bidirectional power conversion circuit PC1 (a first bidirectional power conversion circuit), a bidirectional power conversion circuit PC2 (a second bidirectional power conversion circuit), and a control unit CNT. Note that it is assumed that the bidirectional power conversion circuit PC1 is connected between the input/output terminal T1 and the input/output terminal T2 at all times.

Furthermore, the current sensor Si1 detects a current that flows through the input/output terminal T1, and transmits the detected current to the control unit CNT described later.

Furthermore, the current sensor Si2 detects a current that flows through the input/output terminal T2, and transmits the detected current to the control unit CNT described later.

The switch SW causes the bidirectional power conversion circuit PC2 to be connected between the input/output terminal T1 and the input/output terminal T2 at the time of charging the battery B. Furthermore, at the time of charging the battery B, a commercial power supply is connected between the input/output terminal T1 and the input/output terminal T2. Therefore, at the time of charging the battery B, power can be supplied from the commercial power supply via the bidirectional power conversion circuit PC1 and the bidirectional power conversion circuit PC2 to the battery B. By doing this, at the time of charging the battery B, power to be supplied to the battery B can be increased in comparison with a case where power is supplied from the commercial power supply via only a single bidirectional power conversion circuit to the battery B, and this can reduce the charging time of the battery B.

The switch SW also causes the bidirectional power conversion circuit PC2 to be connected between the input/output terminal T1 and the neutral terminal Tn at the time of supplying power in the single-phase three-wire system. Therefore, at the time of supplying power in the single-phase three-wire system, the bidirectional power conversion circuit PC1 is connected between the input/output terminal T1 and the input/output terminal T2, and the bidirectional power conversion circuit PC2 is connected between the input/output terminal T1 and the neutral terminal Tn.

### Example of Operations of Bidirectional Power Conversion Circuits PC1 and PC2 at the Time of Charging Battery B

At the time of charging the battery B, each of the bidirectional power conversion circuits PC1 and PC2 converts AC power that has been supplied from the commercial power supply via the input/output terminal T1 and the input/output terminal T2 into DC power, and outputs the DC power to the battery B.

### Example of Operations of Bidirectional Power Conversion Circuits PC1 and PC2 at the Time of Supplying Power in Single-Phase Three-Wire System

The bidirectional power conversion circuit PC1 is controlled in such a way that AC 200 V is applied between the input/output terminal T1 and the input/output terminal T2, and the bidirectional power conversion circuit PC2 is controlled in such a way that AC 100 V is applied between the input/output terminal T1 and the neutral terminal Tn. As described above, it is assumed that each of the loads Loα and Loβ is equipment that operates at AC 100 V, the current consumption of the load Loα is Iα, and the current consumption of the load Loβ is Iβ. Accordingly, power consumption at a time when the current consumption Iα has flowed through the load Loα at AC 100 V is power consumption α, and power consumption at a time when the current consumption Iβ has flowed through the load Loβ at AC 100 V is power consumption β.

In a case where the load Loα is only connected between the input/output terminal T1 and the neutral terminal Tn, the bidirectional power conversion circuit PC2 controls DC power supplied from the battery B in such a way that the current consumption Iα flows at AC 100 V. Stated another way, the bidirectional power conversion circuit PC2 performs conversion into AC power that corresponds to the power consumption α of the load Loα, and outputs the AC power between the input/output terminal T1 and the neutral terminal Tn. By doing this, AC power that corresponds to the power consumption α is supplied between the input/output terminal T1 and the neutral terminal Tn, and this can drive the load Loα. Note that the bidirectional power conversion circuit PC1 generates AC 200 V between the input/output terminal T1 and the input/output terminal T2, but a current does not flow.

In a case where the load Loβ is only connected between the input/output terminal T2 and the neutral terminal Tn, the bidirectional power conversion circuit PC2 regenerates a surplus that has not been consumed by the load Loβ from among output power of the bidirectional power conversion circuit PC1, and resupplies the surplus to the battery B. Specifically, the bidirectional power conversion circuit PC1 controls DC power supplied from the battery B in such a way that the current consumption Iβ flows at AC 200 V. As a result, the bidirectional power conversion circuit PC1 performs conversion into AC power that corresponds to twice the power consumption β of the load Loβ, and outputs the AC power between the input/output terminal T1 and the input/output terminal T2. By doing this, AC power that corresponds to the current consumption Iβ at AC 100 V, that is, the power consumption β, is supplied between the input/output terminal T2 and the neutral terminal Tn, and this can drive the load Loβ. Note that the bidirectional power conversion circuit PC2 regenerates AC power that corresponds to the current consumption Iβ at AC 100 V, that is, the power consumption β, between the input/output terminal T1 and the neutral terminal Tn from among the AC power that has been output from the bidirectional power conversion circuit PC1, and resupplies the AC power to the battery B.

In a case where the load Loα is connected between the input/output terminal T1 and the neutral terminal Tn, and the load Loβ is connected between the input/output terminal T2 and the neutral terminal Tn, and in a case where the power consumption α of the load Loα and the power consumption β of the load Loβ are the same as each other, the bidirectional power conversion circuit PC1 controls the DC power supplied from the battery B in such a way that the current consumption Iα(=Iβ) flows at AC 200 V. As a result, the bidirectional power conversion circuit PC1 performs conversion into AC power that corresponds to twice the power consumption α or AC power that corresponds to twice the power consumption β, and outputs the AC power between the input/output terminal T1 and the input/output terminal T2. By doing this, AC power that corresponds to the current consumption Iα(=Iβ) at AC 100 V, that is, each of the power consumption α and the power consumption β, is supplied between the input/output terminal T1 and the neutral terminal Tn and between the input/output terminal T2 and the neutral terminal Tn, and this can simultaneously drive the load Lou and the load Loβ.

In a case where the load Loα is connected between the input/output terminal T1 and the neutral terminal Tn, and the load Loβ is connected between the input/output terminal T2 and the neutral terminal Tn, and in a case where the power consumption α of the load Loα is greater than the power consumption β of the load Loβ, the bidirectional power conversion circuit PC2 supplies, from the battery B, a shortage in the load Loα of the output power of the bidirectional power conversion circuit PC1. Specifically, the bidirectional power conversion circuit PC1 controls DC power supplied from the battery B in such a way that the current consumption Iβ flows at AC 200 V. As a result, the bidirectional power conversion circuit PC1 performs conversion into AC power that corresponds to twice the power consumption β, and outputs the AC power between the input/output terminal T1 and the input/output terminal T2. Furthermore, the bidirectional power conversion circuit PC2 controls DC power supplied from the battery B in such a way that an amount of current obtained by subtracting the current consumption Iβ from the current consumption Iα flows at AC 100 V. Stated another way, conversion is performed into AC power that corresponds to power consumption obtained by subtracting the power consumption β from the power consumption α, and the AC power is output between the input/output terminal T1 and the neutral terminal Tn. By doing this, AC power that corresponds to the power consumption α is supplied between the input/output terminal T1 and the neutral terminal Tn, and AC power that corresponds to the power consumption β is supplied between the input/output terminal T2 and the neutral terminal Tn, and this can simultaneously drive the load Loα and the load Loβ.

In a case where the load Loα is connected between the input/output terminal T1 and the neutral terminal Tn, and the load Loβ is connected between the input/output terminal T2 and the neutral terminal Tn, and in a case where the power consumption β of the load Loβ is greater than the power consumption α of the load Loα, the bidirectional power conversion circuit PC2 regenerates a surplus that has not been consumed by the load Loβ from among output power of the bidirectional power conversion circuit PC1, and resupplies the surplus to the battery B. Specifically, the bidirectional power conversion circuit PC1 controls DC power supplied from the battery B in such a way that the current consumption Iβ flows at AC 200 V. As a result, the bidirectional power conversion circuit PC1 performs conversion into AC power that corresponds to twice the power consumption β, and outputs the AC power between the input/output terminal T1 and the input/output terminal T2. Furthermore, the bidirectional power conversion circuit PC2 performs control to regenerate an amount of current obtained by subtracting the current consumption Iα from the current consumption Iβ at AC 100 V between the input/output terminal T1 and the neutral terminal Tn from among the AC power that has been output from the bidirectional power conversion circuit PC1, and resupply the amount of current to the battery B. Stated another way, AC power that corresponds to power consumption obtained by subtracting the power consumption α from the power consumption β from among the AC power that has been output from the bidirectional power conversion circuit PC1 is converted into DC power, and the DC power is resupplied to the battery B. By doing this, AC power that corresponds to the power consumption α is supplied between the input/output terminal T1 and the neutral terminal Tn, and AC power that corresponds to the power consumption β is supplied between the input/output terminal T2 and the neutral terminal Tn, and this can simultaneously drive the load Loα and the load Loβ.

As described above, in a case where the power consumption α of the load Loα and the power consumption β of the load Loβ are different from each other, power to be output between the input/output terminal T1 and the input/output terminal T2 from the bidirectional power conversion circuit PC1 is adjusted, and power to be output between the input/output terminal T1 and the neutral terminal Tn from the bidirectional power conversion circuit PC2 or power to be input to the bidirectional power conversion circuit PC2 from between the input/output terminal T1 and the neutral terminal Tn is adjusted, and therefore the imbalance in power consumption between the load Loα and the load Loβ can be coped with. Stated another way, in a case where the power consumption α is greater than the power consumption β, or in a case where the power consumption β is greater than the power consumption α, an excess or a shortage of power supplied to the load Loα can be adjusted by using a bidirectional inverter circuit INV2 and a bidirectional DCDC converter circuit CNV2.

By employing such a circuit configuration and performing such control, single-phase charging and single-phase three-wire power feeding can be achieved while interleaved connection is maintained.

### Configurations of Bidirectional Power Conversion Circuits PC1 and PC2

The bidirectional power conversion circuit PC1 includes a bidirectional inverter circuit INV1 (a first bidirectional inverter circuit) and a bidirectional DCDC converter circuit CNV1 (a first bidirectional DCDC converter circuit), and the bidirectional power conversion circuit PC2 includes the bidirectional inverter circuit INV2 (a second bidirectional inverter circuit) and the bidirectional DCDC converter circuit CNV2 (a second bidirectional DCDC converter circuit).

### Example of Operations of Bidirectional Inverter Circuits INV1 and INV2 and Bidirectional DCDC Converter Circuits CNV1 and CNV2 at the Time of Charging Battery B

At the time of charging the battery B, the bidirectional inverter circuit INV1 converts AC power that has been supplied from the commercial power supply into DC power, and outputs the DC power to the bidirectional DCDC converter circuit CNV1, and the bidirectional DCDC converter circuit CNV1 converts the DC power that has been supplied from the bidirectional inverter circuit INV1 into DC power having a different voltage, and outputs the DC power to the battery B.

Furthermore, at the time of charging the battery B, the bidirectional inverter circuit INV2 converts AC power that has been supplied from the commercial power supply into DC power, and outputs the DC power to the bidirectional DCDC converter circuit CNV2, and the bidirectional DCDC converter circuit CNV2 converts the DC power that has been supplied from the bidirectional inverter circuit INV2 into DC power having a different voltage, and outputs the DC power to the battery B.

### Example of Operations of Bidirectional Inverter Circuits INV1 and INV2 and Bidirectional DCDC Converter Circuits CNV1 and CNV2 at the Time of Supplying Power in Single-Phase Three-Wire System

Note that the bidirectional power conversion circuit PC2 performs control in such a way that an AC voltage between the input/output terminal T1 and the neutral terminal Tn is AC voltage Vac, and the bidirectional power conversion circuit PC1 performs control in such a way that an AC voltage between the input/output terminal T1 and the input/output terminal T2 is AC voltage Vac′, which is twice the AC voltage Vac. Furthermore, it is assumed that each of the loads Loα and Loβ is equipment that operates at the AC voltage Vac, the current consumption of the load Loα is Iα, and the current consumption of the load Loβ is Iβ. Accordingly, it is assumed that power consumption of the load Loα at a time when the current consumption Iα has flowed through the load Loα at the AC voltage Vac is α, and power consumption of the load Loβ at a time when the current consumption Iβ has flowed through the load Loβ at the AC voltage Vac is β.

At the time of supplying power in the single-phase three-wire system, in a case where the load Loα is only connected between the input/output terminal T1 and the neutral terminal Tn, the bidirectional DCDC converter circuit CNV2 converts DC power that has been supplied from the battery B into DC power having a different voltage, and outputs the DC power to the bidirectional inverter circuit INV2, and the bidirectional inverter circuit INV2 converts the DC power that has been output from the bidirectional DCDC converter circuit CNV2 into AC power of AC voltage Vac×current consumption Iα, and outputs the AC power between the input/output terminal T1 and the neutral terminal Tn. Stated another way, the bidirectional inverter circuit INV2 outputs AC power that corresponds to the power consumption α of the load Loα between the input/output terminal T1 and the neutral terminal Tn. By doing this, the power consumption α is supplied to the load Loα from between the input/output terminal T1 and the neutral terminal Tn, and this can drive the load Loα.

For example, it is assumed that the AC voltage Vac is AC 100 V, the current consumption Iα is AC 50 A, and the power consumption α is 5 kVA (=AC 100 V×AC 50 A).

In this case, at the time of supplying power in the single-phase three-wire system, the bidirectional inverter circuit INV2 outputs AC power of 5 kVA (=AC 100 V×AC 50 A) between the input/output terminal T1 and the neutral terminal Tn. By doing this, AC power of 5 kVA is supplied to the load Lou from between the input/output terminal T1 and the neutral terminal Tn, and this can drive the load Loα.

Furthermore, at the time of supplying power in the single-phase three-wire system, in a case where the load Loβ is only connected between the input/output terminal T2 and the neutral terminal Tn, the bidirectional inverter circuit INV2 and the bidirectional DCDC converter circuit CNV2 regenerates a surplus (an excess) that has not been consumed by the load Loβ from among power that has been output between the input/output terminal T1 and the input/output terminal T2 from the bidirectional inverter circuit INV1, and resupplies the surplus (the excess) to the battery B. Specifically, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iβ, and outputs the AC power between the input/output terminal T and the input/output terminal T2. Stated another way, the bidirectional inverter circuit INV1 outputs AC power that corresponds to twice the power consumption β between the input/output terminal T1 and the input/output terminal T2. By doing this, the power consumption β is supplied to the load Loβ from between the input/output terminal T2 and the neutral terminal Tn, and this can drive the load Loβ. Furthermore, the bidirectional inverter circuit INV2 converts, into DC power, AC power that corresponds to AC voltage Vac×current consumption Iβ from among power that has been output between the input/output terminal T1 and the neutral terminal Tn from the bidirectional inverter circuit INV1, and outputs the DC power to the bidirectional DCDC converter circuit CNV2, and the bidirectional DCDC converter circuit CNV2 converts the DC power that has been output from the bidirectional inverter circuit INV2 into predetermined DC power, and resupplies the predetermined DC power to the battery B. By doing this, surplus power can be regenerated and resupplied to the battery B at the time of supplying power in the single-phase three-wire system, and this can prevent power consumption of the battery B from decreasing.

For example, it is assumed that the AC voltage Vac′ is AC 200 V, the current consumption Iβ is AC 40 A, and the power consumption β is 4 kVA (=AC 100 V×AC 40 A).

In this case, at the time of supplying power in the single-phase three-wire system, the bidirectional inverter circuit INV1 outputs AC power of 8 kVA (=AC 200 V×AC 40 A) between the input/output terminal T1 and the input/output terminal T2. By doing this, AC power of 4 kVA is supplied to the load Loβ from between the input/output terminal T1 and the neutral terminal Tn, and this can drive the load Loβ.

Furthermore, at the time of supplying power in the single-phase three-wire system, in a case where the load Loα is connected between the input/output terminal T1 and the neutral terminal Tn, and the load Loβ is connected between the input/output terminal T2 and the neutral terminal Tn, and in a case where the power consumption α of the load Loα and the power consumption β of the load Loβ are the same as each other, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iα, or AC power of AC voltage Vac′×current consumption Iβ, and outputs the AC power between the input/output terminal T1 and the input/output terminal T2. Stated another way, the bidirectional inverter circuit INV1 outputs AC power that corresponds to twice the power consumption α or the power consumption β between the input/output terminal T1 and the input/output terminal T2. By doing this, the power consumption α is supplied to the load Loα from between the input/output terminal T1 and the neutral terminal Tn, and the power consumption β is supplied to the load Loβ from between the input/output terminal T2 and the neutral terminal Tn, and this can simultaneously drive the load Loα and the load Loβ.

For example, it is assumed that the AC voltage Vac′ is AC 200 V, the current consumption Iα and the current consumption Iβ are AC 50 A, and the power consumption α of the load Loα and the power consumption β of the load Loβ are 5 kVA (=AC 100 V×AC 50 A).

In this case, at the time of supplying power in the single-phase three-wire system, the bidirectional inverter circuit INV1 outputs AC power of 10 kVA (=AC 200 V×AC 50 A) between the input/output terminal T1 and the input/output terminal T2. By doing this, AC power of 5 kVA is supplied to the load Loα from between the input/output terminal T1 and the neutral terminal Tn, and AC power of 5 kVA is supplied to the load Loβ from between the input/output terminal T2 and the neutral terminal Tn, and this can simultaneously drive the load Loα and the load Loβ.

Furthermore, at the time of supplying power in the single-phase three-wire system, in a case where the load Loα is connected between the input/output terminal T1 and the neutral terminal Tn, and the load Loβ is connected between the input/output terminal T2 and the neutral terminal Tn, and in a case where the power consumption α of the load Loα is greater than the power consumption β of the load Loβ, the bidirectional inverter circuit INV2 and the bidirectional DCDC converter circuit CNV2 compensate for a shortage of output power of the bidirectional inverter circuit INV1 from among the power consumption α of the load Loα. Specifically, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iβ, and outputs the AC power between the input/output terminal T1 and the input/output terminal T2. Stated another way, the bidirectional inverter circuit INV1 outputs AC power that corresponds to twice the power consumption β of the load Loβ between the input/output terminal T1 and the input/output terminal T2.

Furthermore, the bidirectional DCDC converter circuit CNV2 converts DC power that has been supplied from the battery B into DC power having a different voltage, and outputs the DC power to the bidirectional inverter circuit INV2, and the bidirectional inverter circuit INV2 converts the DC power that has been output from the bidirectional DCDC converter circuit CNV2 into a shortage of AC power that corresponds to AC voltage Vac×(amount of current obtained by subtracting current consumption Iβ from current consumption Iα), and outputs the shortage of AC power between the input/output terminal T1 and the neutral terminal Tn. Stated another way, the bidirectional inverter circuit INV2 outputs a shortage of power that corresponds to power consumption obtained by subtracting the power consumption β from the power consumption α between the input/output terminal T1 and the neutral terminal Tn. By doing this, the power consumption α is supplied to the load Loα from between the input/output terminal T1 and the neutral terminal Tn, and the power consumption β is supplied to the load Loβ from between the input/output terminal T2 and the neutral terminal Tn, and this can simultaneously drive the load Loα and the load Loβ.

For example, it is assumed that the AC voltage Vac is AC 100 V, the AC voltage Vac′ is AC 200 V, the current consumption Iα is AC 50 A, the current consumption Iβ is AC 40 A, the power consumption α of the load Loα is 5 kVA (=AC 100 V×AC 50 A), and the power consumption β of the load Loβ is 4 kVA (=AC 100 V×AC 40 A).

In this case, at the time of supplying power in the single-phase three-wire system, the bidirectional inverter circuit INV1 outputs AC power of 8 kVA (=AC 200 V×AC 40 A) between the input/output terminal T1 and the input/output terminal T2, and the bidirectional inverter circuit INV2 outputs AC power of 1 kVA (=AC 100 V×(AC 50 A−AC 40 A)) between the input/output terminal T1 and the neutral terminal Tn. By doing this, AC power of 5 kVA is supplied to the load Loα from between the input/output terminal T1 and the neutral terminal Tn, AC power of 4 kVA is supplied to the load Loβ from between the input/output terminal T2 and the neutral terminal Tn, and the loads Loα and Loβ can be simultaneously driven.

Furthermore, at the time of supplying power in the single-phase three-wire system, in a case where the load Loα is connected between the input/output terminal T1 and the neutral terminal Tn, and the load Loβ is connected between the input/output terminal T2 and the neutral terminal Tn, and in a case where the power consumption β of the load Loβ is greater than the power consumption α of the load Loα, the bidirectional inverter circuit INV2 and the bidirectional DCDC converter circuit CNV2 regenerates a surplus (an excess) that has not been consumed by the load Loα from among power that has been output between the input/output terminal T1 and the input/output terminal T2 from the bidirectional inverter circuit INV1, and resupplies the surplus (the excess) to the battery B. Specifically, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iβ, and outputs the AC power between the input/output terminal T1 and the input/output terminal T2. Stated another way, the bidirectional inverter circuit INV1 outputs AC power that corresponds to twice the power consumption β of the load Loβ between the input/output terminal T1 and the input/output terminal T2. Furthermore, the bidirectional inverter circuit INV2 converts, into DC power, AC power of AC voltage Vac×(current consumption Iβ−current consumption Iα), which is a surplus from among AC power that has been output between the input/output terminal T1 and the neutral terminal Tn from the bidirectional inverter circuit INV1, and outputs the DC power to the bidirectional DCDC converter circuit CNV2, and the bidirectional DCDC converter circuit CNV2 converts the DC power that has been output from the bidirectional inverter circuit INV2 into predetermined DC power, and resupplies the predetermined DC power to the battery B. Stated another way, the bidirectional inverter circuit INV2 outputs, to the bidirectional DCDC converter circuit CNV2, AC power that corresponds to power consumption obtained by subtracting the power consumption α from the power consumption β from among the AC power that has been output between the input/output terminal T1 and the neutral terminal Tn from the bidirectional inverter circuit INV1. By doing this, the power consumption α is supplied to the load Loα from between the input/output terminal T1 and the neutral terminal Tn, and the power consumption β is supplied to the load Loβ from between the input/output terminal T2 and the neutral terminal Tn, and this can simultaneously drive the load Loα and the load Loβ.

For example, it is assumed that the AC voltage Vac is AC 100 V, the AC voltage Vac′ is AC 200 V, the current consumption Iα is AC 40 A, the current consumption Iβ is AC 50 A, the power consumption α of the load Loα is 4 kVA (=AC 100 V×AC 40 A), and the power consumption β of the load Loβ is 5 KVA (=AC 100 V×AC 50 A).

In this case, at the time of supplying power in the single-phase three-wire system, the bidirectional inverter circuit INV1 outputs AC power of 10 kVA (=AC 200 V×AC 50 A) between the input/output terminal T1 and the input/output terminal T2, and the bidirectional inverter circuit INV2 converts, into DC power, AC power of 1 kVA (=AC 100 V×(AC 50 A−AC 40 A)) from among power (5 kVA) that has been output between the input/output terminal T1 and the neutral terminal Tn from the bidirectional inverter circuit INV1, and outputs the DC power to the bidirectional DCDC converter circuit CNV2. By doing this, AC power of 4 kVA is supplied to the load Loα from between the input/output terminal T1 and the neutral terminal Tn, AC power of 5 kVA is supplied to the load Loβ from between the input/output terminal T2 and the neutral terminal Tn, and the loads Loα and Loβ can be simultaneously driven.

### Configuration of Bidirectional Inverter Circuit INV1

The bidirectional inverter circuit INV1 is an interleaved totem-pole bridgeless power factor circuit (PFC), and includes a coil L11 (a first coil), a coil L12 (a second coil), a switching element Q11 (a first switching element), a switching element Q12 (a second switching element), a switching element Q13 (a third switching element), a switching element Q14 (a fourth switching element), a switching element Q15 (a fifth switching element), a switching element Q16 (a sixth element), a capacitor C1, voltage sensors Sv11 and Sv12, and current sensors Si11 and Si12. Furthermore, the bidirectional inverter circuit INV1 includes an arm AR1 (a first arm) to which the switching element Q11 and the switching element Q12 are connected in series, an arm AR2 (a second arm) to which the switching element Q13 and the switching element Q14 are connected in series, and an arm AR3 (a third arm) to which the switching element Q15 and the switching element Q16 are connected in series. For example, the switching elements Q11 to Q16 are constituted by a metal oxide semiconductor field effect transistor (MOSFET).

One terminal of the coil L11 is connected to one terminal of the coil L12 and the input/output terminal T1, and another terminal of the coil L11 is connected to a connection point between a source terminal of the switching element Q11 and a drain terminal of the switching element Q12. Another terminal of the coil L12 is connected to a connection point between a source terminal of the switching element Q13 and a drain terminal of the switching element Q14. A connection point between a source terminal of the switching element Q15 and a drain terminal of the switching element Q16 is connected to the input/output terminal T2. Respective drain terminals of the switching elements Q11, Q13, and Q15 are connected to each other, and are connected to one terminal of the capacitor C1. Respective source terminals of the switching elements Q12, Q14, and Q16 are connected to each other, and are connected to another terminal of the capacitor C1. Stated another way, in the coil L11, one end is connected to a connection point between the switching element Q11 and the switching element Q12, and another end is connected to the input/output terminal T1. Note that the one end of the coil L11 may be connected to the connection point between the switching element Q11 and the switching element Q12 via a wiring line, or may be directly connected to the connection point. Furthermore, in the coil L12, one end is connected to a connection point between the switching element Q13 and the switching element Q14, and another end is connected to the input/output terminal T1. Note that the one end of the coil L12 may be connected to the connection point between the switching element Q13 and the switching element Q14 via a wiring line, or may be directly connected to the connection point.

The voltage sensor Sv11 detects a voltage applied between the input/output terminal T1 and the input/output terminal T2 at the time of charging the battery B or at the time of supplying power in the single-phase three-wire system, and transmits the detected voltage to the control unit CNT.

The voltage sensor Sv12 detects a voltage applied to the capacitor C1 at the time of charging the battery B or at the time of supplying power in the single-phase three-wire system, and transmits the detected voltage to the control unit CNT.

The current sensor Sill detects a current that flows through the coil L11 at the time of charging the battery B or at the time of supplying power in the single-phase three-wire system, and transmits the detected current to the control unit CNT.

The current sensor Si12 detects a current that flows through the coil L12 at the time of charging the battery B or at the time of supplying power in the single-phase three-wire system, and transmits the detected current to the control unit CNT.

### Configuration of Bidirectional Inverter Circuit INV2

The bidirectional inverter circuit INV2 is an interleaved totem-pole bridgeless PFC similarly to the bidirectional inverter circuit INV1, and includes a coil L21 (a third coil), a coil L22 (a fourth coil), a switching element Q21 (a seventh switching element), a switching element Q22 (an eighth switching element), a switching element Q23 (a ninth switching element), a switching element Q24 (a tenth switching element), a switching element Q25 (an eleventh switching element), a switching element Q26 (a twelfth element), a capacitor C2, voltage sensors Sv21 and Sv22, and current sensors Si21 and Si22. For example, the switching elements Q21 to Q26 are constituted by a MOSFET. Furthermore, the bidirectional inverter circuit INV2 includes an arm AR4 (a fourth arm) to which the switching element Q21 and the switching element Q22 are connected in series, an arm AR5 (a fifth arm) to which the switching element Q23 and the switching element Q24 are connected in series, and an arm AR6 (a sixth arm) to which the switching element Q25 and the switching element Q26 are connected in series. In a case where the coils L11, L12, L21, and L22 are not distinguished from each other, they are simply referred to as coils L. Furthermore, the bidirectional inverter circuits INV1 and INV2 are not limited to a totem-pole bridgeless PFC. For example, the bidirectional inverter circuits INV1 and INV2 may be interleaved non-totem-pole bridgeless PFCs.

One terminal of the coil L21 is connected to one terminal of the coil L22 and the input/output terminal T1, and another terminal of the coil L21 is connected to a connection point between a source terminal of the switching element Q21 and a drain terminal of the switching element Q22. Another terminal of the coil L22 is connected to a connection point between a source terminal of the switching element Q23 and a drain terminal of the switching element Q24. A connection point between a source terminal of the switching element Q25 and a drain terminal of the switching element Q26 is connected via the switch SW to the input/output terminal T2 and the neutral terminal Tn. Respective drain terminals of the switching elements Q21, Q23, and Q25 are connected to each other, and are connected to one terminal of the capacitor C2.

Respective source terminals of the switching elements Q22, Q24, and Q26 are connected to each other, and are connected to another terminal of the capacitor C2. Stated another way, in the coil L21, one end is connected to a connection point between the switching element Q21 and the switching element Q22, and another end is connected to the input/output terminal T1. Note that the one end of the coil L21 may be connected to the connection point between the switching element Q21 and the switching element Q22 via a wiring line, or may be directly connected to the connection point. Furthermore, in the coil L22, one end is connected to a connection point between the switching element Q23 and the switching element Q24, and another end is connected to the input/output terminal T1. Note that the one end of the coil L22 may be connected to the connection point between the switching element Q23 and the switching element Q24 via a wiring line, or may be directly connected to the connection point. Furthermore, the switch SW is a switch in which one end is connected to the bidirectional inverter circuit INV2, and another end is switchably connected to the neutral terminal Tn and the input/output terminal T2. Note that the one end of the switch SW may be connected to the bidirectional inverter circuit INV2 via a wiring line, or may be directly connected to the bidirectional inverter circuit INV2. Furthermore, the other end of the switch SW may be connected to the neutral terminal Tn or the input/output terminal T2 via a wiring line, or may be directly connected to the neutral terminal Tn or the input/output terminal T2.

The voltage sensor Sv21 detects a voltage applied between the input/output terminal T1 and the input/output terminal T2 at the time of charging the battery B, detects a voltage applied between the input/output terminal T1 and the neutral terminal Tn at the time of supplying power in the single-phase three-wire system, and transmits the detected voltages to the control unit CNT.

The voltage sensor Sv22 detects a voltage applied to the capacitor C2 at the time of charging the battery B or at the time of supplying power in the single-phase three-wire system, and transmits the detected voltage to the control unit CNT.

The current sensor Si21 detects a current that flows through the coil L21 at the time of charging the battery B or at the time of supplying power in the single-phase three-wire system, and transmits the detected current to the control unit CNT.

The current sensor Si22 detects a current that flows through the coil L22 at the time of charging the battery B or at the time of supplying power in the single-phase three-wire system, and transmits the detected current to the control unit CNT.

As described above, the bidirectional inverter circuits INV1 and INV2 are interleaved bidirectional inverter circuits, and therefore at the time of supplying power in the single-phase three-wire system, the bidirectional inverter circuits INV1 and INV2 can cause currents that flow through two respective arms that include the coils L11 and L12 to flow to the load Loα, and can cause currents that flow through two respective arms that include the coils L21 and L22 to flow to the load Loβ. Therefore, power to be supplied to the loads Loα and Loβ can be increased in comparison with a case where the bidirectional inverter circuits INV1 and INV2 are not of an interleaved type, that is, a case where a current that flows through one arm is caused to flow to the load Loα, and a current that flows through one arm is caused to flow to the load Loβ. Furthermore, an increase in the number of arms of the bidirectional inverter circuit INV1 enables single-phase three-wire output, even if the bidirectional inverter circuit INV1 in which the arm AR1 and the arm AR2 are of the interleaved type, and the bidirectional inverter circuit INV2 in which the arm AR4 and the arm AR5 are of the interleaved type are employed.

### Configuration of Control Unit CNT

The control unit CNT is constituted by, for example, a processor or a programmable device (a field programmable gate array (FPGA), a programmable logic device (PLD), or the like), and controls respective operations of the switch SW and the bidirectional power conversion circuits PC1 and PC2. Note that the control unit CNT may be constituted by a plurality of control units, such as a control unit that controls an operation of the switch SW, a control unit that controls an operation of the bidirectional power conversion circuit PC1, and a control unit that controls an operation of the bidirectional power conversion circuit PC2.

### Example of Control on Operation of Bidirectional Inverter Circuit INV1 at the Time of Charging Battery B

In a case where currents that have been detected by the current sensors Si11 and Si12 are positive (in a case where a current flows from the commercial power supply via the coils L11 and L12 to the switching elements Q11 to Q14), the control unit CNT repeats an operation to turn on the switching elements Q12 and Q13, and turn off the switching elements Q11 and Q14, and then turn off the switching elements Q12 and Q13, and turn on the switching elements Q11 and Q14, while maintaining the switching element Q16 in an ON state at all times, and maintaining the switching element Q15 in an OFF state at all times. Furthermore, in a case where currents that have been detected by the current sensors Si11 and Si12 are negative (in a case where a current flows from the switching elements Q11 to Q14 via the coils L11 and L12 to the commercial power supply), the control unit CNT repeats an operation to turn on the switching elements Q12 and Q13, and turn off the switching elements Q11 and Q14, and then turn off the switching elements Q12 and Q13, and turn on the switching elements Q11 and Q14, while maintaining the switching element Q15 in the ON state at all times, and maintaining the switching element Q16 in the OFF state at all times. Stated another way, a power factor improvement operation performed by the coil L11 and the switching elements Q11, Q12, Q15, and Q16 and a power factor improvement operation performed by the coil L12 and the switching elements Q15, Q16, Q13, and Q14 are performed out of phase. By doing this, at the time of charging the battery B, AC power that has been input from the commercial power supply via the input/output terminal T1 and the input/output terminal T2 to the bidirectional inverter circuit INV1 is improved in a power factor, and is rectified, and the rectified power is smoothed by the capacitor C1, and is output to the bidirectional DCDC converter circuit CNV1.

### Example of Control on Operation of Bidirectional Inverter Circuit INV2 at the Time of Charging Battery B or at the Time of Supplying Power in Single-Phase Three-Wire System (at the Time of Regeneration)

In a case where currents that have been detected by the current sensors Si21 and Si22 are positive (in a case where a current flows from the commercial power supply or the bidirectional inverter circuit INV1 via the coils L11 and L12 to the switching elements Q21 to Q24), the control unit CNT repeats an operation to turn on the switching elements Q22 and Q23, and turn off the switching elements Q21 and Q24, and then turn off the switching elements Q22 and Q23, and turn on the switching elements Q21 and Q24, while maintaining the switching element Q26 in the ON state at all times, and maintaining the switching element Q25 in the OFF state at all times. Furthermore, in a case where currents that have been detected by the current sensors Si21 and Si22 are negative (in a case where a current flows from the switching elements Q21 to Q24 via the coils L21 and L22 to the commercial power supply or the bidirectional inverter circuit INV1), the control unit CNT repeats an operation to turn on the switching elements Q22 and Q23, and turn off the switching elements Q21 and Q24, and then turn off the switching elements Q22 and Q23, and turn on the switching elements Q21 and Q24, while maintaining the switching element Q25 in the ON state at all times, and maintaining the switching element Q26 in the OFF state at all times. Stated another way, a power factor improvement operation performed by the coil L21 and the switching elements Q21, Q22, Q25, and Q26 and a power factor improvement operation performed by the coil L22 and the switching elements Q25, Q26, Q23, and Q24 are performed out of phase. By doing this, at the time of charging the battery B or at the time of supplying power in the single-phase three-wire system, AC power that has been input from the commercial power supply or from between the input/output terminal T1 and the neutral terminal Tn to the bidirectional inverter circuit INV2 is improved in the power factor, and is simultaneously rectified, and the rectified power is smoothed by the capacitor C2, and is output to the bidirectional DCDC converter circuit CNV2.

### Example of Control on Operation of Bidirectional Inverter Circuit INV1 at the Time of Supplying Power in Single-Phase Three-Wire System

In a case where the polarity of an AC current that flows from the bidirectional inverter circuit INV1 to the load Lo is positive (in a case where a current flows from the switching elements Q11 to Q14 to the coils L11 and L12), the control unit CNT repeats an operation to turn on the switching elements Q11 and Q13, and turn off the switching elements Q12 and Q14, and then turn off the switching elements Q11 and Q13, and turn on the switching elements Q12 and Q14, while maintaining the switching element Q16 in the ON state at all times, and maintaining the switching element Q15 in the OFF state at all times. Furthermore, in a case where the polarity of an AC current that flows from the bidirectional inverter circuit INV1 to the load Lo is negative (in a case where a current flows from the coils L11 and L12 to the switching elements Q11 to Q14), the control unit CNT repeats an operation to turn on the switching elements Q12 and Q14, and turn off the switching elements Q11 and Q13, and then turn off the switching elements Q12 and Q14, and turn on the switching elements Q11 and Q13, while maintaining the switching element Q15 in the ON state at all times, and maintaining the switching element Q16 in the OFF state at all times. By doing this, DC power that has been input from the bidirectional DCDC converter circuit CNV1 via the capacitor C1 to the bidirectional inverter circuit INV1 is converted into AC power by the bidirectional inverter circuit INV1, and the AC power is supplied to the load Lo.

### Example of Control on Operation of Bidirectional Inverter Circuit INV2 at the Time of Supplying Power in Single-Phase Three-Wire System (at the Time of Supplying Power to Load Loα)

In a case where the polarity of an AC current that flows from the bidirectional inverter circuit INV2 to the load Lo is positive (in a case where a current flows from the switching elements Q21 to Q24 to the coils L21 and L22), the control unit CNT repeats an operation to turn on the switching elements Q21 and Q23, and turn off the switching elements Q22 and Q24, and then turn off the switching elements Q21 and Q23, and turn on the switching elements Q22 and Q24, while maintaining the switching element Q26 in the ON state at all times, and maintaining the switching element Q25 in the OFF state at all times. Furthermore, in a case where the polarity of an AC current that flows from the bidirectional inverter circuit INV2 to the load Lo is negative (in a case where a current flows from the coils L21 and L22 to the switching elements Q21 to Q24), the control unit CNT repeats an operation to turn on the switching elements Q22 and Q24, and turn off the switching elements Q21 and Q23, and then turn off the switching elements Q22 and Q24, and turn on the switching elements Q21 and Q23, while maintaining the switching element Q25 in the ON state at all times, and maintaining the switching element Q26 in the OFF state at all times. By doing this, DC power that has been input from the bidirectional DCDC converter circuit CNV2 via the capacitor C2 to the bidirectional inverter circuit INV2 is converted into AC power by the bidirectional inverter circuit INV2, and the AC power is supplied to the load Lo.

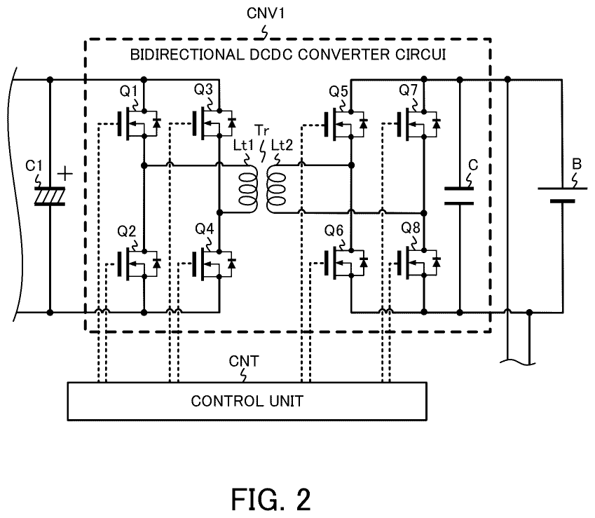

FIG. 2 is a diagram illustrating a circuit example of the bidirectional DCDC converter circuit CNV1. Note that a circuit example of the bidirectional DCDC converter circuit CNV2 may be similar to the circuit example of the bidirectional DCDC converter circuit CNV1 illustrated in FIG. 2.

The bidirectional DCDC converter circuit CNV1 illustrated in FIG. 2 includes a transformer Tr, switching elements Q1 to Q4 that constitute a primary bridge circuit of the transformer Tr, switching elements Q5 to Q8 that constitute a secondary bridge circuit of the transformer Tr, and a capacitor C. Note that the switching elements Q1 to Q8 are constituted by, for example, a MOSFET.

Respective drain terminals of the switching elements Q1 and Q3 are connected to one terminal of the capacitor C1, and respective source terminals of the switching elements Q2 and Q4 are connected to another terminal of the capacitor C1. A connection point between a source terminal of the switching element Q1 and a drain terminal of the switching element Q2 is connected to one terminal of a primary coil Lt1 of the transformer Tr, and a connection point between a source terminal of the switching element Q3 and a drain terminal of the switching element Q4 is connected to another terminal of the primary coil Lt1. Respective drain terminals of the switching elements Q5 and Q7 are connected to one terminal of the capacitor C and a positive electrode terminal of the battery B, and respective source terminals of the switching elements Q6 and Q8 are connected to another terminal of the capacitor C and a negative electrode terminal of the battery B. A connection point between a source terminal of the switching element Q5 and a drain terminal of the switching element Q6 is connected to one terminal of a secondary coil Lt2 of the transformer Tr, and a connection point between a source terminal of the switching element Q7 and a drain terminal of the switching element Q8 is connected to another terminal of the secondary coil Lt2.

Note that a circuit example of the bidirectional DCDC converter circuit CNV1 is not limited to the circuit example illustrated in FIG. 2, if it is possible to convert DC power that has been output from the bidirectional inverter circuit INV1 into predetermined DC power, and supply the DC power to the battery B at the time of charging the battery B, and to convert DC power that has been supplied from the battery B into DC power having a different voltage, and supply the DC power to the bidirectional inverter circuit INV1 at the time of supplying power in the single-phase three-wire system. The similar is applied to the bidirectional DCDC converter circuit CNV2.

### Example of Control on Operation of Bidirectional DCDC Converter Circuit CNV1 at the Time of Charging Battery B

The control unit CNT repeats an operation to turn on the switching elements Q1 and Q4, and turn off the switching elements Q2 and Q3, and then turn off the switching elements Q1 and Q4, and turn on the switching elements Q2 and Q3, causes the primary coil Lt1 to generate AC, and causes the switching elements Q5 to Q8 to synchronously rectify the AC in such a way that power to be output to the battery B follows target power Pt1. Note that the target power Pt1 is set on the basis of, for example, a voltage of the battery B.

### Example of Control on Operation of Bidirectional DCDC Converter Circuit CNV1 at the Time of Supplying Power in Single-Phase Three-Wire System

The control unit CNT repeats an operation to turn on the switching elements Q6 and Q7, and turn off the switching elements Q5 and Q8, and then turn off the switching elements Q6 and Q7, and turn on the switching elements Q5 and Q8, causes the secondary coil Lt2 to generate AC, and causes the switching elements Q1 to Q4 to synchronously rectify the AC in such a way that power to be output to the bidirectional inverter circuit INV1 follows target power Pt2. Note that the target power Pt2 is set on the basis of, for example a voltage of the capacitor C1.

Note that in a case where the bidirectional DCDC converter circuit CNV1 is driven according to the dual active bridge (DAB) scheme, respective duty ratios of driving signals that drive the switching elements Q1 to Q8 may be 50 [%], and a phase of the driving signals of the switching elements Q1 to Q4 and a phase of the driving signals of the switching elements Q5 to Q8 may be shifted from each other in accordance with the target power Pt1 and the target power Pt2.

Furthermore, an example of control on an operation of the bidirectional DCDC converter circuit CNV2 at the time of charging the battery B or at the time of supplying power in the single-phase three-wire system may be similar to the example of control on the operation of the bidirectional DCDC converter circuit CNV1 at the time of charging the battery B or at the time of supplying power in the single-phase three-wire system.

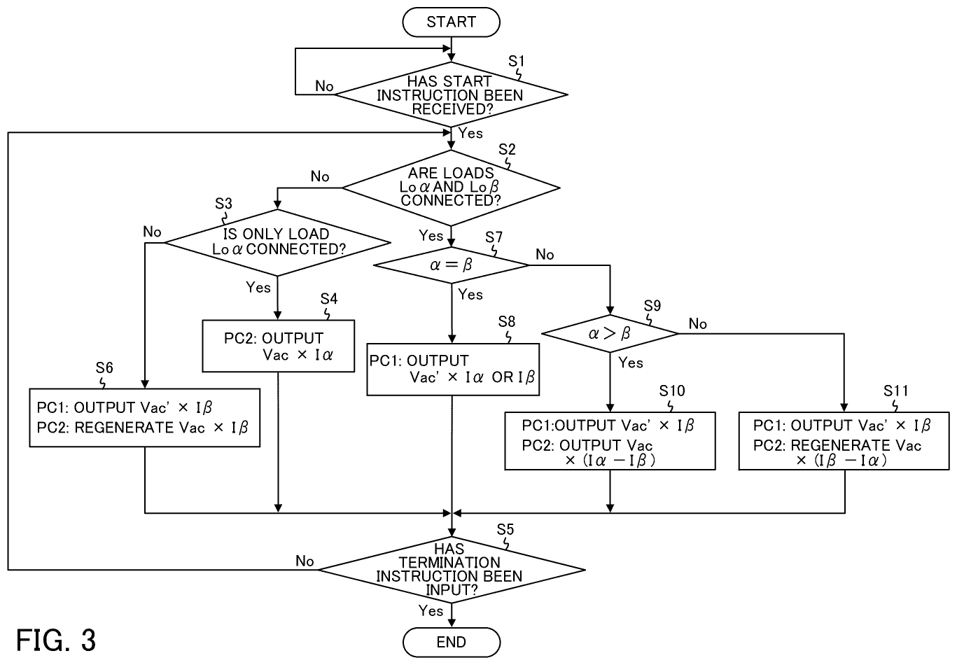

FIG. 3 is a flowchart illustrating an example of an operation of the control unit CNT at the time of supplying power in the single-phase three-wire system according to the first embodiment. Note that the bidirectional power conversion circuit PC2 performs control in such a way that an AC voltage between the input/output terminal T1 and the neutral terminal Tn is AC voltage Vac, and the bidirectional power conversion circuit PC1 performs control in such a way that an AC voltage between the input/output terminal T1 and the input/output terminal T2 is AC voltage Vac′, which is twice the AC voltage Vac. Furthermore, it is assumed that each of the loads Loα and Loβ is equipment that operates at the AC voltage Vac, the current consumption of the load Loα is Iα, and the current consumption of the load Loβ is Iβ. Accordingly, it is assumed that power consumption of the load Loα at a time when the current consumption Iα has flowed through the load Loα at the AC voltage Vac is α, and power consumption of the load Loβ at a time when the current consumption Iβ has flowed through the load Loβ at the AC voltage Vac is β.

First, when the control unit CNT has received an instruction to start the supply of power in the single-phase three-wire system from a user or the like (step S1: Yes), the control unit CNT starts control on operations of the switch SW and the bidirectional power conversion circuits PC1 and PC2, and determines whether the loads Loα and Loβ are connected to the input/output terminals T1 and T2 (step S2). For example, the control unit CNT may determine whether the loads Loα and Loβ are connected to the input/output terminals T1 and T2 on the basis of currents that are detected by the current sensors Si1 and Si2 when predetermined AC power (for example, AC power that does not exceed rated power of the loads Loα and Loβ) has been output between the input/output terminal T1 and the input/output terminal T2 from the bidirectional inverter circuit INV1. Furthermore, for example, after the control unit CNT has determined that the load Loα is connected to the input/output terminal T1, the control unit CNT may obtain the power consumption α of the load Loα on the basis of an AC current that has been detected by the current sensor Si1, or the like. As another example, after the control unit CNT has determined that the load Loβ is connected to the input/output terminal T2, the control unit CNT may obtain the power consumption β of the load Loβ on the basis of an AC current that has been detected by the current sensor Si2, or the like.

Next, in a case where the control unit CNT has determined that the load Loα is only connected between the input/output terminal T1 and the neutral terminal Tn (step S2: No, step S3: Yes), the control unit CNT controls an operation of the bidirectional power conversion circuit PC2 in such a way that power that corresponds to AC voltage Vac×current consumption Iα is output from the battery B via the bidirectional power conversion circuit PC2 to between the input/output terminal T1 and the neutral terminal Tn (step S4), and the processing proceeds to step S5. This enables the power consumption α to be supplied from the bidirectional charger Ch to the load Loα.

Furthermore, in a case where the control unit CNT has determined that the load Loβ is only connected between the input/output terminal T2 and the neutral terminal Tn (step S2: No, step S3: No), the control unit CNT controls operations of the bidirectional power conversion circuits PC1 and PC2 in such a way that power that corresponds to AC voltage Vac′×current consumption Iβ is output from the battery B via the bidirectional power conversion circuit PC1 to between the input/output terminal T1 and the input/output terminal T2, and power that corresponds to AC voltage Vac×current consumption Iβ is regenerated and resupplied from between the input/output terminal T1 and the neutral terminal Tn via the bidirectional power conversion circuit PC2 to the battery B (step S6), and the processing proceeds to step S5. This enables the power consumption β to be supplied from the bidirectional charger Ch to the load Loβ. Note that power does not necessarily need to be regenerated and resupplied from between the input/output terminal T1 and the neutral terminal Tn via the bidirectional power conversion circuit PC2 to the battery B.

Furthermore, in a case where the control unit CNT has determined that the loads Loα and Loβ are connected to the input/output terminals T1 and T2 (step S2: Yes), and in a case where the control unit CNT has determined that the power consumption α and the power consumption β are the same as each other (step S7: Yes), the control unit CNT controls an operation of the bidirectional power conversion circuit PC1 in such a way that power that corresponds to AC voltage Vac′×current consumption Iαor current consumption Iβ is output from the battery B via the bidirectional power conversion circuit PC1 to between the input/output terminal T1 and the input/output terminal T2 (step S8), and the processing proceeds to step S5. This enables the power consumption α or the power consumption β to be supplied from the bidirectional charger Ch to the loads Loα and Loβ, respectively.

Furthermore, in a case where the control unit CNT has determined that the loads Loα and Loβ are connected to the input/output terminals T1 and T2 (step S2: Yes), and in a case where the power consumption α is greater than the power consumption β (step S7: No, step S9: Yes), the control unit CNT controls operations of the bidirectional power conversion circuits PC1 and PC2 in such a way that power that corresponds to AC voltage Vac′×current consumption Iβ is output from the battery B via the bidirectional power conversion circuit PC1 to between the input/output terminal T1 and the input/output terminal T2, and power that corresponds to AC voltage Vac×(current consumption Iα−current consumption Iβ) is output from the battery B via the bidirectional power conversion circuit PC2 to between the input/output terminal T1 and the neutral terminal Tn (step S10), and the processing proceeds to step S5. This enables the power consumption α to be supplied from the bidirectional charger Ch to the load Loα, and enables the power consumption β to be supplied from the bidirectional charger Ch to the load Loβ.

Furthermore, in a case where the control unit CNT has determined that the loads Loα and Loβ are connected to the input/output terminals T1 and T2 (step S2: Yes), and in a case where the power consumption β is greater than the power consumption α (step S7: No, step S9: No), the control unit CNT controls operations of the bidirectional power conversion circuits PC1 and PC2 in such a way that power that corresponds to AC voltage Vac′×current consumption Iβ is output from the battery B via the bidirectional power conversion circuit PC1 to between the input/output terminal T1 and the input/output terminal T2, and power that corresponds to AC voltage Vac×(current consumption Iβ−current consumption Iα) is regenerated and resupplied from between the input/output terminal T1 and the neutral terminal Tn via the bidirectional power conversion circuit PC2 to the battery B (step S11), and the processing proceeds to step S5. This enables the power consumption α to be supplied from the bidirectional charger Ch to the load Loα, and enables the power consumption β to be supplied from the bidirectional charger Ch to the load Loβ.

Furthermore, when an instruction to terminate the supply of power in the single-phase three-wire system has not been input (step S5: No), the control unit CNT repeats steps S2 to S11 to continue the supply of power in the single-phase three-wire system, and when the instruction to terminate the supply of power in the single-phase three-wire system has been input (step S5: Yes), the control unit CNT stops control on the operations of the bidirectional power conversion circuits PC1 and PC2 to terminate the supply of power in the single-phase three-wire system.

### Second Embodiment

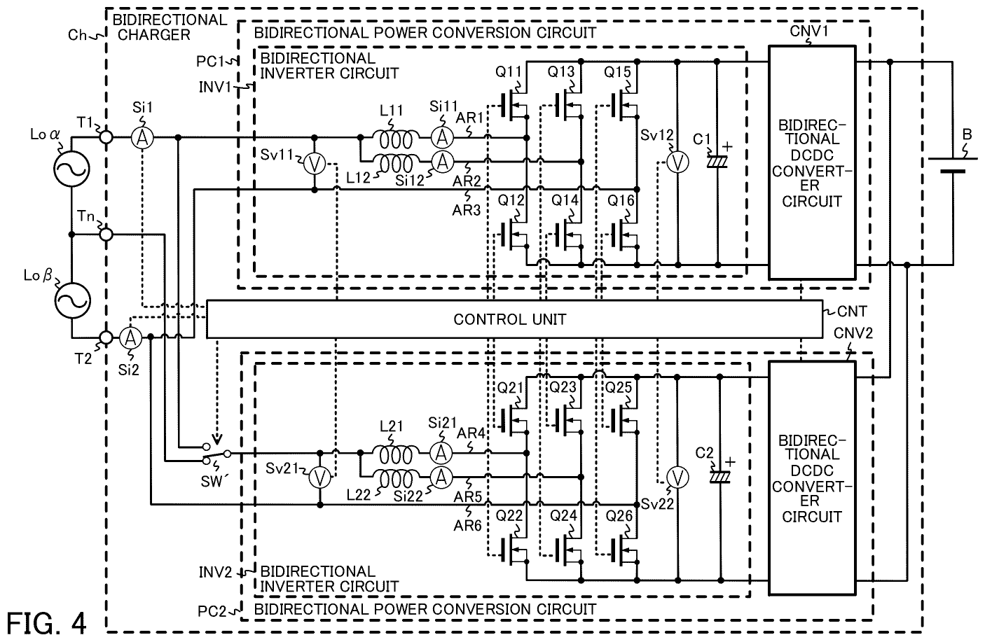

FIG. 4 is a diagram illustrating an example of a bidirectional charger according to a second embodiment. Note that in FIG. 4, a configuration that is the same as the configuration illustrated in FIG. 1 is denoted by the same reference sign, and the description thereof is omitted.

The bidirectional charger Ch illustrated in FIG. 4 is different from the bidirectional charger Ch illustrated in FIG. 1 in that a switch SW′ causes the bidirectional power conversion circuit PC2 to be connected between the input/output terminal T2 and the neutral terminal Tn at the time of supplying power in the single-phase three-wire system. At the time of charging the battery B, the switch SW′ causes the bidirectional power conversion circuit PC2 to be connected between the input/output terminal T1 and the input/output terminal T2.

Stated another way, in the bidirectional charger Ch illustrated in FIG. 4, at the time of supplying power in the single-phase three-wire system, the bidirectional power conversion circuit PC1 is connected between the input/output terminal T1 and the input/output terminal T2, and the bidirectional power conversion circuit PC2 is connected between the input/output terminal T2 and the neutral terminal Tn. It is assumed that the loads Loα and Loβ are electrical products that operate at AC 100 V, or the like. It is assumed that the current consumption of the load Loα is Iα, and the current consumption of the load Loβ is Iβ. Accordingly, power consumption at a time when the current consumption Iα has flowed through the load Loα at AC 100 V is power consumption α, and power consumption at a time when the current consumption Iβ has flowed through the load Loβ at AC 100 V is power consumption β. The power consumption α and the power consumption β are not necessarily constant, and the power consumption α and the power consumption β can change according to a change in current consumption. The power consumption α and the power consumption β may have the same value, the power consumption α may be greater than the power consumption β, or the power consumption β may be greater than the power consumption α. Furthermore, at the time of supplying power in the single-phase three-wire system, a voltage to be applied between the input/output terminal T1 and the neutral terminal Tn, and a voltage to be applied between the input/output terminal T2 and the neutral terminal Tn are controlled to have an equal value of AC 100 V.

### Example of Operations of Bidirectional Power Conversion Circuits PC1 and PC2 at the Time of Supplying Power in Single-Phase Three-Wire System

The bidirectional power conversion circuit PC1 is controlled in such a way that AC 200 V is applied between the input/output terminal T1 and the input/output terminal T2, and the bidirectional power conversion circuit PC2 is controlled in such a way that AC 100 V is applied between the input/output terminal T2 and the neutral terminal Tn.

In a case where the load Loα is only connected between the input/output terminal T1 and the neutral terminal Tn, the bidirectional power conversion circuit PC2 regenerates a surplus that has not been consumed by the load Loα from among output power of the bidirectional power conversion circuit PC1, and resupplies the surplus to the battery B. Specifically, the bidirectional power conversion circuit PC1 controls DC power supplied from the battery B in such a way that the current consumption Iα flows at AC 200 V. As a result, the bidirectional power conversion circuit PC1 performs conversion into AC power that corresponds to twice the power consumption α of the load Loα, and outputs the AC power between the input/output terminal T1 and the input/output terminal T2. By doing this, AC power that corresponds to the current consumption Iα at AC 100 V, that is, the power consumption α, is supplied between the input/output terminal T1 and the neutral terminal Tn, and this can drive the load Loα. Note that the bidirectional power conversion circuit PC2 regenerates AC power that corresponds to the current consumption Iα at AC 100 V, that is, the power consumption α, between the input/output terminal T2 and the neutral terminal Tn from among the AC power that has been output from the bidirectional power conversion circuit PC1, and resupplies the AC power to the battery B.

In a case where the load Loβ is only connected between the input/output terminal T2 and the neutral terminal Tn, the bidirectional power conversion circuit PC2 controls DC power supplied from the battery B in such a way that the current consumption Iβ flows at AC 100 V. Stated another way, the bidirectional power conversion circuit PC2 performs conversion into AC power that corresponds to the power consumption β of the load Loβ, and outputs the AC power between the input/output terminal T2 and the neutral terminal Tn. By doing this, AC power that corresponds to the power consumption β is supplied between the input/output terminal T2 and the neutral terminal Tn, and this can drive the load Loβ.

In a case where the load Loα is connected between the input/output terminal T1 and the neutral terminal Tn, and the load Loβ is connected between the input/output terminal T2 and the neutral terminal Tn, and in a case where the power consumption α of the load Loα is greater than the power consumption β of the load Loβ, the bidirectional power conversion circuit PC2 regenerates a surplus that has not been consumed by the load Loβ from among output power of the bidirectional power conversion circuit PC1, and resupplies the surplus to the battery B. Specifically, the bidirectional power conversion circuit PC1 controls DC power supplied from the battery B in such a way that the current consumption Iα flows at AC 200 V. As a result, the bidirectional power conversion circuit PC1 performs conversion into AC power that corresponds to twice the power consumption α, and outputs the AC power between the input/output terminal T1 and the input/output terminal T2. Furthermore, the bidirectional power conversion circuit PC2 performs control to regenerate an amount of current obtained by subtracting the current consumption Iβ from the current consumption Iα at AC 100 V between the input/output terminal T2 and the neutral terminal Tn from among AC power that has been output from the bidirectional power conversion circuit PC1, and resupply the amount of current to the battery B. Stated another way, AC power that corresponds to power consumption obtained by subtracting the power consumption β from the power consumption α from among the AC power that has been output from the bidirectional power conversion circuit PC1 is converted into DC power, and the DC power is resupplied to the battery B. By doing this, AC power that corresponds to the power consumption α is supplied between the input/output terminal T1 and the neutral terminal Tn, and AC power that corresponds to the power consumption β is supplied between the input/output terminal T2 and the neutral terminal Tn, and this can simultaneously drive the load Loα and the load Loβ.

In a case where the load Loα is connected between the input/output terminal T1 and the neutral terminal Tn, and the load Loβ is connected between the input/output terminal T2 and the neutral terminal Tn, and in a case where the power consumption β of the load Loβ is greater than the power consumption α of the load Loα, the bidirectional power conversion circuit PC2 supplies, from the battery B, a shortage in the load Loβ of the output power of the bidirectional power conversion circuit PC1. Specifically, the bidirectional power conversion circuit PC1 controls DC power supplied from the battery B in such a way that the current consumption Iα flows at AC 200 V. As a result, the bidirectional power conversion circuit PC1 performs conversion into AC power that corresponds to twice the power consumption α, and outputs the AC power between the input/output terminal T1 and the input/output terminal T2. Furthermore, the bidirectional power conversion circuit PC2 controls DC power supplied from the battery B in such a way that an amount of current obtained by subtracting the current consumption Iα from current consumption Iβ flows at AC 100 V. Stated another way, conversion is performed into AC power that corresponds to power consumption obtained by subtracting the power consumption α from the power consumption β, and the AC power is output between the input/output terminal T2 and the neutral terminal Tn. By doing this, AC power that corresponds to the power consumption α is supplied between the input/output terminal T1 and the neutral terminal Tn, and AC power that corresponds to the power consumption β is supplied between the input/output terminal T2 and the neutral terminal Tn, and this can simultaneously drive the load Loα and the load Loβ.

As described above, in a case where the power consumption α of the load Loα and the power consumption β of the load Loβ are different from each other, power to be output between the input/output terminal T1 and the input/output terminal T2 from the bidirectional power conversion circuit PC1 is adjusted, and power to be output between the input/output terminal T2 and the neutral terminal Tn from the bidirectional power conversion circuit PC2 or power to be input to the bidirectional power conversion circuit PC2 from between the input/output terminal T2 and the neutral terminal Tn is adjusted, and therefore the imbalance in power consumption between the load Loα and the load Loβ can be coped with. Stated another way, in a case where the power consumption α is greater than the power consumption β, or in a case where the power consumption β is greater than the power consumption α, an excess or a shortage of power to be supplied to the load Loβ can be adjusted by using the bidirectional inverter circuit INV2 and the bidirectional DCDC converter circuit CNV2.

By employing such a circuit configuration and performing such control, single-phase charging and single-phase three-wire power feeding can be achieved while interleaved connection is maintained.

Note that an example of operations of the bidirectional power conversion circuits PC1 and PC2 at the time of charging the battery B, and an example of operations of the bidirectional power conversion circuits PC1 and PC2 in a case where the power consumption α of the load Loα and the power consumption β of the load Loβ are the same as each other at the time of supplying power in the single-phase three-wire system are similar to the examples according to the first embodiment, and therefore the description thereof is omitted.

### Example of Operations of Bidirectional Inverter Circuits INV1 and INV2 and Bidirectional DCDC Converter Circuits CNV1 and CNV2 at the Time of Supplying Power in Single-Phase Three-Wire System

Note that the bidirectional power conversion circuit PC2 performs control in such a way that an AC voltage between the input/output terminal T2 and the neutral terminal Tn is AC voltage Vac, and the bidirectional power conversion circuit PC1 performs control in such a way that an AC voltage between the input/output terminal T1 and the input/output terminal T2 is AC voltage Vac′, which is twice the AC voltage Vac. Furthermore, it is assumed that each of the loads Loα and Loβ is equipment that operates at the AC voltage Vac, the current consumption of the load Loα is Iα, and the current consumption of the load Loβ is Iβ. Accordingly, it is assumed that power consumption of the load Loα at a time when the current consumption Iα has flowed through the load Loα at the AC voltage Vac is α, and power consumption of the load Loβ at a time when the current consumption Iβ has flowed through the load Loβ at the AC voltage Vac is β.

At the time of supplying power in the single-phase three-wire system, in a case where the load Loα is only connected between the input/output terminal T1 and the neutral terminal Tn, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iα, and outputs the AC power between the input/output terminal T1 and the input/output terminal T2. Stated another way, the bidirectional inverter circuit INV1 outputs AC power that corresponds to twice the power consumption α between the input/output terminal T1 and the input/output terminal T2. By doing this, the power consumption α is supplied to the load Loα from between the input/output terminal T1 and the neutral terminal Tn, and this can drive the load Loα. Furthermore, the bidirectional inverter circuit INV2 converts, into DC power, AC power that corresponds to AC voltage Vac×current consumption Iα from among power that has been output between the input/output terminal T2 and the neutral terminal Tn from the bidirectional inverter circuit INV1, and outputs the DC power to the bidirectional DCDC converter circuit CNV2, and the bidirectional DCDC converter circuit CNV2 converts the DC power that has been output from the bidirectional inverter circuit INV2 into predetermined DC power, and resupplies the predetermined DC power to the battery B. By doing this, surplus power can be regenerated and resupplied to the battery B at the time of supplying power in the single-phase three-wire system, and this can prevent power consumption of the battery B from decreasing.

For example, it is assumed that the AC voltage Vac′ is AC 200 V, the current consumption Iα is AC 50 A, and the power consumption α is 5 kVA (=AC 100 V×AC 50 A).

In this case, at the time of supplying power in the single-phase three-wire system, the bidirectional inverter circuit INV1 outputs AC power of 10 kVA (=AC 200 V×50 A) between the input/output terminal T1 and the input/output terminal T2. By doing this, AC power of 5 kVA is supplied to the load Loα from between the input/output terminal T1 and the neutral terminal Tn, and this can drive the load Loα.

Furthermore, at the time of supplying power in the single-phase three-wire system, in a case where the load Loβ is only connected between the input/output terminal T2 and the neutral terminal Tn, the bidirectional DCDC converter circuit CNV2 converts DC power that has been supplied from the battery B into DC power having a different voltage, and outputs the DC power to the bidirectional inverter circuit INV2, and the bidirectional inverter circuit INV2 converts the DC power that has been output from the bidirectional DCDC converter circuit CNV2 into AC power of AC voltage Vac×current consumption Iβ, and outputs the AC power between the input/output terminal T2 and the neutral terminal Tn. Stated another way, the bidirectional inverter circuit INV2 outputs AC power that corresponds to the power consumption β between the input/output terminal T2 and the neutral terminal Tn. By doing this, the power consumption β is supplied to the load Loβ from between the input/output terminal T2 and the neutral terminal Tn, and this can drive the load Loβ.

For example, it is assumed that the AC voltage Vac is AC 100 V, the current consumption Iβ is AC 50 A, and the power consumption β is 5 kVA (=AC 100 V×AC 50 A). In this case, at the time of supplying power in the single-phase three-wire system, the bidirectional inverter circuit INV2 outputs AC power of 5 kVA (=AC 100 V×50 A) between the input/output terminal T2 and the neutral terminal Tn. By doing this, AC power of 5 kVA is supplied to the load Loβ from between the input/output terminal T2 and the neutral terminal Tn, and this can drive the load Loβ.

Furthermore, at the time of supplying power in the single-phase three-wire system, in a case where the load Loα is connected between the input/output terminal T1 and the neutral terminal Tn, and the load Loβ is connected between the input/output terminal T2 and the neutral terminal Tn, and in a case where the power consumption α of the load Loα is greater than the power consumption β of the load Loβ, the bidirectional inverter circuit INV2 and the bidirectional DCDC converter circuit CNV2 regenerates a surplus (an excess) that has not been consumed by the load Loβ from among power that has been output between the input/output terminal T1 and the input/output terminal T2 from the bidirectional inverter circuit INV1, and resupplies the surplus (the excess) to the battery B. Specifically, the bidirectional inverter circuit INV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iα, and outputs the AC power between the input/output terminal T1 and the input/output terminal T2. Stated another way, the bidirectional inverter circuit INV1 outputs AC power that corresponds to twice the power consumption α of the load Loα between the input/output terminal T1 and the input/output terminal T2. Furthermore, the bidirectional inverter circuit INV2 converts, into DC power, AC power of AC voltage Vac×(current consumption Iα−current consumption Iβ), which is a surplus from among AC power that has been output between the input/output terminal T2 and the neutral terminal Tn from the bidirectional inverter circuit INV1, and outputs the DC power to the bidirectional DCDC converter circuit CNV2, and the bidirectional DCDC converter circuit CNV2 converts the DC power that has been output from the bidirectional inverter circuit INV2 into predetermined DC power, and resupplies the predetermined DC power to the battery B. Stated another way, the bidirectional inverter circuit INV2 outputs, to the bidirectional DCDC converter circuit CNV2, AC power that corresponds to power consumption obtained by subtracting the power consumption β from the power consumption α from among the AC power that has been output between the input/output terminal T2 and the neutral terminal Tn from the bidirectional inverter circuit INV1. By doing this, the power consumption α is supplied to the load Loα from between the input/output terminal T1 and the neutral terminal Tn, and the power consumption β is supplied to the load Loβ from between the input/output terminal T2 and the neutral terminal Tn, and this can simultaneously drive the load Loα and the load Loβ.

For example, it is assumed that the AC voltage Vac is AC 100 V, the AC voltage Vac′ is AC 200 V, the current consumption Iα is AC 50 A, the current consumption Iβ is AC 40 A, the power consumption α of the load Loα is 5 kVA (=AC 100 V×AC 50 A), and the power consumption β of the load Loβ is 4 kVA (=AC 100 V×AC 40 A).

In this case, at the time of supplying power in the single-phase three-wire system, the bidirectional inverter circuit INV1 outputs AC power of 10 kVA (=AC 200 V×AC 50 A) between the input/output terminal T1 and the input/output terminal T2, and the bidirectional inverter circuit INV2 converts, into DC power, AC power of 1 kVA (=AC 100 V×(AC 50 A−AC 40 A)) from among power (5 kVA) that has been output between the input/output terminal T2 and the neutral terminal Tn from the bidirectional inverter circuit INV1, and outputs the DC power to the bidirectional DCDC converter circuit CNV2. By doing this, AC power of 5 kVA is supplied to the load Loα from between the input/output terminal T1 and the neutral terminal Tn, AC power of 4 kVA is supplied to the load Loβ from between the input/output terminal T2 and the neutral terminal Tn, and the loads Loα and Loβ can be simultaneously driven.

Furthermore, at the time of supplying power in the single-phase three-wire system, in a case where the load Loα is connected between the input/output terminal T1 and the neutral terminal Tn, and the load Loβ is connected between the input/output terminal T2 and the neutral terminal Tn, and in a case where the power consumption β of the load Loβ is greater than the power consumption α of the load Loα, the bidirectional inverter circuit INV2 and the bidirectional DCDC converter circuit CNV2 compensate for a shortage of output power of the bidirectional inverter circuit INV1 from among the power consumption β of the load Loβ. Specifically, the bidirectional DCDC converter circuit CNV1 converts DC power that has been supplied from the battery B into DC power having a different voltage, and outputs the DC power to the bidirectional inverter circuit INV1, and the bidirectional inverter circuit INV1 converts the DC power that has been output from the bidirectional DCDC converter circuit CNV1 into AC power of AC voltage Vac′×current consumption Iα, and outputs the AC power between the input/output terminal T1 and the input/output terminal T2. Stated another way, the bidirectional inverter circuit INV1 outputs AC power that corresponds to twice the power consumption α of the load Loα between the input/output terminal T1 and the input/output terminal T2. Furthermore, the bidirectional DCDC converter circuit CNV2 converts DC power that has been supplied from the battery B into DC power having a different voltage, and outputs the DC power to the bidirectional inverter circuit INV2, and the bidirectional inverter circuit INV2 converts the DC power that has been output from the bidirectional DCDC converter circuit CNV2 into a shortage of AC power that corresponds to AC voltage Vac×(amount of current obtained by subtracting current consumption la from current consumption Iβ), and outputs the shortage of AC power between the input/output terminal T2 and the neutral terminal Tn. Stated another way, the bidirectional inverter circuit INV2 outputs a shortage of power that corresponds to power consumption obtained by subtracting the power consumption α from the power consumption β between the input/output terminal T2 and the neutral terminal Tn. By doing this, the power consumption α is supplied to the load Loα from between the input/output terminal T1 and the neutral terminal Tn, and the power consumption β is supplied to the load Loβ from between the input/output terminal T2 and the neutral terminal Tn, and this can simultaneously drive the load Loα and the load Loβ.

For example, it is assumed that the AC voltage Vac is AC 100 V, the AC voltage Vac′ is AC 200 V, the current consumption Iα is AC 40 A, the current consumption Iβ is AC 50 A, the power consumption α of the load Loα is 4 kVA, and the power consumption β of the load Loβ is 5 kVA.

In this case, at the time of supplying power in the single-phase three-wire system, the bidirectional inverter circuit INV1 outputs AC power of 8 kVA (=AC 200 V×AC 40 A) between the input/output terminal T1 and the input/output terminal T2, and the bidirectional inverter circuit INV2 outputs AC power of 1 kVA (=AC 100 V×(AC 50 A−AC 40 A) between the input/output terminal T2 and the neutral terminal Tn. By doing this, AC power of 4 k [VA] is supplied to the load Loα from between the input/output terminal T1 and the neutral terminal Tn, AC power of 5 k [VA] is supplied to the load Loβ from between the input/output terminal T2 and the neutral terminal Tn, and the loads Lou and Loβ can be simultaneously driven.

Note that an example of operations of the bidirectional inverter circuits INV1 and INV2 and the bidirectional DCDC converter circuits CNV1 and CNV2 in a case where the load Loα is connected between the input/output terminal T1 and the neutral terminal Tn, and the load Loβ is connected between the input/output terminal T2 and the neutral terminal Tn, and in a case where the power consumption α of the load Loα and the power consumption β of the load Loβ are the same as each other is similar to the example according to the first embodiment, and the description there of is omitted.

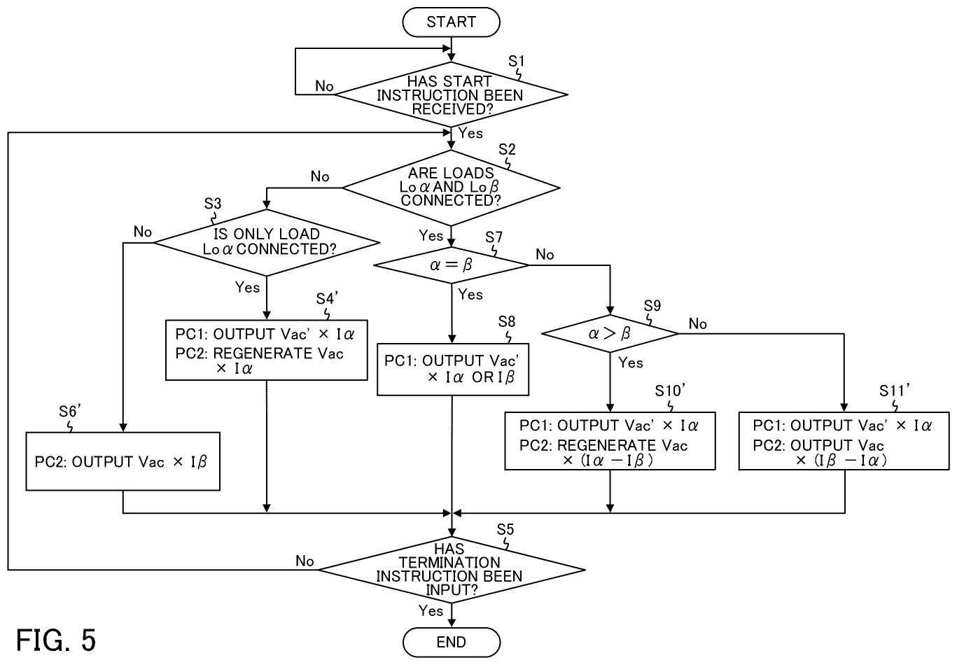

FIG. 5 is a flowchart illustrating an operation of the control unit CNT at the time of supplying power in the single-phase three-wire system according to the second embodiment. Note that steps S1 to S3, S5, S7, and S9 illustrated in FIG. 5 are similar to steps S1 to S3, S5, S7, and S9 illustrated in FIG. 3, and therefore the description thereof is omitted. Furthermore, the bidirectional power conversion circuit PC2 performs control in such a way that an AC voltage between the input/output terminal T2 and the neutral terminal Tn is AC voltage Vac, and the bidirectional power conversion circuit PC1 performs control in such a way that an AC voltage between the input/output terminal T1 and the input/output terminal T2 is AC voltage Vac′, which is twice the AC voltage Vac. Furthermore, it is assumed that each of the loads Loα and Loβ is equipment that operates at the AC voltage Vac, the current consumption of the load Loα is Iα, and the current consumption of the load Loβ is Iβ. Accordingly, it is assumed that power consumption of the load Loα at a time when the current consumption Iα has flowed through the load Loα at the AC voltage Vac is α, and power consumption of the load Loβ at a time when the current consumption Iβ has flowed through the load Loβ at the AC voltage Vac is β.

In a case where the control unit CNT has determined that the load Loα is only connected between the input/output terminal T1 and the neutral terminal Tn (step S2: No, step S3: Yes), the control unit CNT controls operations of the bidirectional power conversion circuits PC1 and PC2 in such a way that power that corresponds to AC voltage Vac′×current consumption Iα is output from the battery B via the bidirectional power conversion circuit PC1 to between the input/output terminal T1 and the input/output terminal T2, and power that corresponds to AC voltage Vac×current consumption Iα is regenerated and resupplied from between the input/output terminal T2 and the neutral terminal In via the bidirectional power conversion circuit PC2 to the battery B (step S4′), and the processing proceeds to step S5. This enables the power consumption α to be supplied from the bidirectional charger Ch to the load Loα. Note that power does not necessarily need to be regenerated and resupplied from between the input/output terminal T2 and the neutral terminal Tn via the bidirectional power conversion circuit PC2 to the battery B.

Furthermore, in a case where the control unit CNT has determined that the load Loβ is only connected between the input/output terminal T2 and the neutral terminal Tn (step S2: No, step S3: No), the control unit CNT controls an operation of the bidirectional power conversion circuit PC2 in such a way that power that corresponds to AC voltage Vac×current consumption Iβ is output from the battery B via the bidirectional power conversion circuit PC2 to between the input/output terminal T2 and the neutral terminal Tn (step S6′), and the processing proceeds to step S5. This enables the power consumption β to be supplied from the bidirectional charger Ch to the load Loβ.

Furthermore, in a case where the control unit CNT has determined that the loads Loα and Loβ are connected to the input/output terminals T1 and T2 (step S2: Yes), and in a case where the power consumption α is greater than the power consumption β (step S7: No, step S9: Yes), the control unit CNT controls operations of the bidirectional power conversion circuits PC1 and PC2 in such a way that power that corresponds to AC voltage Vac′×current consumption Iα is output from the battery B via the bidirectional power conversion circuit PC1 to between the input/output terminal T1 and the input/output terminal T2, and power that corresponds to AC voltage Vac×(current consumption Iα−current consumption Iβ) is regenerated and resupplied from between the input/output terminal T2 and the neutral terminal Tn via the bidirectional power conversion circuit PC2 to the battery B (step S10′), and the processing proceeds to step S5. This enables the power consumption α to be supplied from the bidirectional charger Ch to the load Loα, and enables the power consumption β to be supplied from the bidirectional charger Ch to the load Loβ.

Furthermore, in a case where the control unit CNT has determined that the loads Loα and Loβ are connected to the input/output terminals T1 and T2 (step S2: Yes), and in a case where the power consumption β is greater than the power consumption α (step S7: No, step S9: No), the control unit CNT controls operations of the bidirectional power conversion circuits PC1 and PC2 in such a way that power that corresponds to AC voltage Vac′×current consumption Iα is output from the battery B via the bidirectional power conversion circuit PC1 to between the input/output terminal T1 and the input/output terminal T2, and power that corresponds to AC voltage Vac×(current consumption Iβ−current consumption Iα) is output from the battery B via the bidirectional power conversion circuit PC2 to between the input/output terminal T2 and the neutral terminal Tn (step S11′), and the processing proceeds to step S5. This enables the power consumption α to be supplied from the bidirectional charger Ch to the load Loα, and enables the power consumption β to be supplied from the bidirectional charger Ch to the load Loβ.

As described above, the bidirectional charger Ch according to the first embodiment includes the input/output terminals T1 and T2, the neutral terminal Tn, the bidirectional inverter circuits INV1 and INV2, and the bidirectional DCDC converter circuits CNV1 and CNV2. Therefore, by simultaneously controlling the bidirectional inverter circuits INV1 and INV2 and the bidirectional DCDC converter circuits CNV1 and CNV2, in a case where power consumed by the load Loα is greater than power consumed by the load Loβ, power obtained by subtracting the power consumed by the load Loβ from the power consumed by the load Loα can be supplied via the bidirectional DCDC converter circuit CNV2 and the bidirectional inverter circuit INV2 to the load Loα. Furthermore, in a case where the power consumed by the load Loβ is greater than the power consumed by the load Loα, power obtained by subtracting the power consumed by the load Loα from the power consumed by the load Loβ can be regenerated and resupplied to the battery B via the bidirectional inverter circuit INV2 and the bidirectional DCDC converter circuit CNV2. Stated another way, the bidirectional charger Ch according to the first embodiment can cope with the imbalance in power consumption between the loads Lo at the time of supplying power in the single-phase three-wire system.

Furthermore, the bidirectional charger Ch according to the second embodiment includes the input/output terminals T1 and T2, the neutral terminal Tn, the bidirectional inverter circuits INV1 and INV2, and the bidirectional DCDC converter circuits CNV1 and CNV2. Therefore, by simultaneously controlling the bidirectional inverter circuits INV1 and INV2 and the bidirectional DCDC converter circuits CNV1 and CNV2, in a case where power consumed by the load Loα is greater than power consumed by the load Loβ, power obtained by subtracting the power consumed by the load Loβ from the power consumed by the load Loα can be regenerated and resupplied to the battery B via the bidirectional DCDC converter circuit CNV2 and the bidirectional inverter circuit INV2. Furthermore, in a case where the power consumed by the load Loβ is greater than the power consumed by the load Loα, power obtained by subtracting the power consumed by the load Loα from the power consumed by the load Loβ can be supplied to the load Loβ via the bidirectional inverter circuit INV2 and the bidirectional DCDC converter circuit CNV2. Stated another way, the bidirectional charger Ch according to the second embodiment can cope with the imbalance in power consumption between the loads Lo at the time of supplying power in the single-phase three-wire system.

Furthermore, the bidirectional chargers Ch according to the first and second embodiments include the switch SW. Therefore, in a case where the commercial power supply is connected to the input/output terminals T1 and T2, and another end of the switch SW is connected to the input/output terminal T2 or the input/output terminal T1, DC power can be supplied via the bidirectional inverter circuit INV1 and the bidirectional DCDC converter circuit CNV1 to the battery B, and DC power can be supplied via the bidirectional inverter circuit INV2 and the bidirectional DCDC converter circuit CNV2 to the battery B.

Furthermore, in the bidirectional charger Ch according to the first embodiment, the arm AR1, the arm AR2, and the arm AR3 are connected in parallel, a connection point between the switching elements Q15 and Q16 is connected to the input/output terminal T2, the AR4, the arm AR5, and the arm AR6 are connected in parallel, and a connection point between the switching elements Q25 and Q26 is connected to the neutral terminal Tn. Therefore, an increase in the number of arms of the bidirectional inverter circuit INV1 enables single-phase three-wire output, even if the bidirectional inverter circuit INV1 in which the arm AR1 and the arm AR2 are of the interleaved type, and the bidirectional inverter circuit INV2 in which the arm AR4 and the arm AR5 are of the interleaved type are employed, and this can avoid a deterioration in performance of elements.

Furthermore, in the bidirectional charger Ch according to the second embodiment, the arm AR1, the arm AR2, and the arm AR3 are connected in parallel, a connection point between the switching elements Q15 and Q16 is connected to the input/output terminal T2, the AR4, the arm AR5, and the arm AR6 are connected in parallel, and a connection point between the coils L21 and L22 is connected to the neutral terminal Tn. Therefore, an increase in the number of arms of the bidirectional inverter circuit INV1 enables single-phase three-wire output, even if the bidirectional inverter circuit INV1 in which the arm AR1 and the arm AR2 are of the interleaved type, and the bidirectional inverter circuit INV2 in which the arm AR4 and the arm AR5 are of the interleaved type are employed, and this can avoid a deterioration in performance of elements. Note that the present invention is not limited to the embodiments described above, and various modifications or alterations can be made without departing from the gist of the present invention.

### First Variation

In the first and second embodiments described above, a single battery B is connected to the bidirectional power conversion circuits PC1 and PC2, but the battery B may be connected to the bidirectional power conversion circuit PC1, and a battery that is different from the battery B may be connected to the bidirectional power conversion circuit PC2. In the case of such a configuration, at the time of charging the battery B and the other battery, power is supplied from the commercial power supply via the bidirectional power conversion circuit PC1 to the battery B, and power is supplied from the commercial power supply via the bidirectional power conversion circuit PC2 to the other battery. Furthermore, at the time of supplying power in the single-phase three-wire system, it enters into a state where power can be supplied from the battery B via the bidirectional power conversion circuit PC1 to a side of the loads Lo, and a state where a shortage of power can be supplied from the other battery via the bidirectional power conversion circuit PC2 to the side of the loads Lo, and surplus power can be regenerated and resupplied via the bidirectional power conversion circuit PC2 to the other battery.

### Second Variation

In the first and second embodiments described above, the bidirectional inverter circuits INV1 and INV2 are of the interleaved type, but the bidirectional inverter circuits INV1 and INV2 do not necessarily need to be of the interleaved type. For example, in the bidirectional inverter circuit INV1, the switching elements Q11 and Q12 and the arm AR1, or the switching elements Q13 and Q14 and the arm AR2 may be omitted. Furthermore, in the bidirectional inverter circuit INV2, the switching elements Q21 and Q22 and the arm AR4, or the switching elements Q23 and Q24 and the arm AR5 may be omitted.

### Third Variation

In the first and second embodiments described above, the switch SW may be omitted. In this case, the connection point between the switching elements Q25 and Q26 according to the first embodiment is directly connected to the neutral terminal Tn, and the connection point between the coils L21 and L22 according to the second embodiment is directly connected to the neutral terminal Tn.

What is claimed is:

1. A bidirectional charger comprising:
a first input/output terminal that is connected to a first load;
a second input/output terminal that is connected to a second load that is connected in series to the first load;
a neutral terminal that is connected to a connection point between the first load and the second load, and is grounded;
a first bidirectional inverter circuit that is connected to the first input/output terminal and the second input/output terminal;
a second bidirectional inverter circuit that is connected to the first input/output terminal and the neutral terminal;
a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit;
a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and
a control unit that controls the first bidirectional inverter circuit, the second bidirectional inverter circuit, the first bidirectional DCDC converter circuit, and the second bidirectional DCDC converter circuit.

2. A bidirectional charger comprising:
a first input/output terminal that is connected to a first load;
a second input/output terminal that is connected to a second load that is connected in series to the first load;
a neutral terminal that is connected to a connection point between the first load and the second load, and is grounded;
a first bidirectional inverter circuit that is connected to the first input/output terminal and the second input/output terminal;
a second bidirectional inverter circuit that is connected to the first input/output terminal;
a switch in which one end is connected to the second bidirectional inverter circuit, and another end is switchably connected to the neutral terminal and the second input/output terminal;
a first bidirectional DCDC converter circuit that converts DC power that has been supplied from the first bidirectional inverter circuit into DC power having a different voltage to output the DC power after conversion to a battery, and converts DC power that has been supplied from the battery into DC power having a different voltage to output the DC power after conversion to the first bidirectional inverter circuit;
a second bidirectional DCDC converter circuit that converts DC power that has been supplied from the second bidirectional inverter circuit into DC power having a different voltage to output the DC power after conversion to the battery, and converts DC power that has been supplied from the battery into DC power having a different voltage to output the DC power after conversion to the second bidirectional inverter circuit; and
a control unit that controls the first bidirectional inverter circuit, the second bidirectional inverter circuit, the first bidirectional DCDC converter circuit, and the second bidirectional DCDC converter circuit.

3. The bidirectional charger according to claim 1, wherein
the first bidirectional inverter circuit includes:
a first arm to which a first switching element and a second switching element are connected in series;
a second arm to which a third switching element and a fourth switching element are connected in series;
a third arm to which a fifth switching element and a sixth switching element are connected in series;
a first coil in which one end is connected to a connection point between the first switching element and the second switching element, and another end is connected to the first input/output terminal; and
a second coil in which one end is connected to a connection point between the third switching element and the fourth switching element, and another end is connected to the first input/output terminal,
the first arm, the second arm, and the third arm are connected in parallel, and a connection point between the fifth switching element and the sixth switching element is connected to the second input/output terminal,
the second bidirectional inverter circuit includes:
a fourth arm to which a seventh switching element and an eighth switching element are connected in series;
a fifth arm to which a ninth switching element and a tenth switching element are connected in series;
a sixth arm to which an eleventh switching element and a twelfth switching element are connected in series;
a third coil in which one end is connected to a connection point between the seventh switching element and the eighth switching element, and another end is connected to the first input/output terminal; and
a fourth coil in which one end is connected to a connection point between the ninth switching element and the tenth switching element, and another end is connected to the first input/output terminal, and
the fourth arm, the fifth arm, and the sixth arm are connected in parallel, and a connection point between the eleventh switching element and the twelfth switching element is connected to the neutral terminal.

4. The bidirectional charger according to claim 2, wherein
the first bidirectional inverter circuit includes:
a first arm to which a first switching element and a second switching element are connected in series;
a second arm to which a third switching element and a fourth switching element are connected in series;
a third arm to which a fifth switching element and a sixth switching element are connected in series;
a first coil in which one end is connected to a connection point between the first switching element and the second switching element, and another end is connected to the first input/output terminal; and
a second coil in which one end is connected to a connection point between the third switching element and the fourth switching element, and another end is connected to the first input/output terminal,
the first arm, the second arm, and the third arm are connected in parallel, and a connection point between the fifth switching element and the sixth switching element is connected to the second input/output terminal,
the second bidirectional inverter circuit includes:
a fourth arm to which a seventh switching element and an eighth switching element are connected in series;
a fifth arm to which a ninth switching element and a tenth switching element are connected in series;
a sixth arm to which an eleventh switching element and a twelfth switching element are connected in series;
a third coil in which one end is connected to a connection point between the seventh switching element and the eighth switching element, and another end is connected to the first input/output terminal; and
a fourth coil in which one end is connected to a connection point between the ninth switching element and the tenth switching element, and another end is connected to the first input/output terminal, and
the fourth arm, the fifth arm, and the sixth arm are connected in parallel, and a connection point between the eleventh switching element and the twelfth switching element is connected to the one end of the switch.
